(19) United States
(12) Patent Application Publication
(10) Pub. No.: US 2007/0074146 A1
(43) Pub. Date: Mar. 29, 2007

(54) Method for designing mask pattern and method for manufacturing semiconductor device

(75) Inventors: Toshihiko Tanaka, Tokyo (JP); Osamu Suga, Tokyo (JP); Tsuneo Terasawa, Tokyo (JP); Tetsuya Higuchi, Tsukuba (JP); Hidenori Sakanashi, Tsukuba (JP); Hirokazu Nosato, Tsukuba (JP); Tetsuaki Matsunawa, Tsukuba (JP)

Correspondence Address: Stanley P. Fisher;Reed Smith LLP, Suite 1400, 3110 Fairview Park Drive, Falls Church, VA, 22042-4503, US

(73) Assignees: Renesas Technology Corp.; National Institute of Advanced Industrial Science and Technology

(21) Appl. No.: 11/526,783

(22) Filed: Sep. 26, 2006

(30) Foreign Application Priority Data
Sep. 26, 2005 (JP) JP2005-277332

(51) Int. Cl. G06F 17/50

(52) U.S. Cl. 716/21; 716/8

(57) ABSTRACT

A semiconductor chip is manufactured using a cell library pattern obtained by performing OPC (optical proximity correction) process at the time of a cell single arrangement to a cell library pattern which forms a basic structure of a semiconductor circuit pattern in advance. A plurality of cell libraries are arranged to design a mask pattern and a correction amount of OPC performed to the cell libraries is changed with taking into account the influence of a pattern of cell libraries arranged around a target cell. Further, a cell group with the same arrangement of surrounding cells including the target cell is extracted and is registered as a cell set, and a cell set with the same cell arrangement as that of the registered cell set is produced by copying without re-calculating OPC inside the cell set.

### CROSS-REFERENCE TO RELATED APPLICATION

The present application claims priority from Japanese Patent Application No. JP 2005-277332 filed on Sep. 26, 2005, the content of which is hereby incorporated by reference into this application.

### TECHNICAL FIELD OF THE INVENTION

The present invention relates to a manufacturing technology of a semiconductor device. In particular, it relates to a technology effectively applied to a mask pattern designing process for forming a pattern smaller than an exposure wavelength in optical lithography.

### BACKGROUND OF THE INVENTION

Semiconductor devices can be mass-produced by repeating photolithography steps of irradiating exposure light to a mask which is a master plate in which a circuit pattern is written to transfer the pattern onto a semiconductor substrate (hereinafter, referred to as wafer) via a reduction optical system. In recent years, it has been required to form a pattern having a dimension smaller than an exposure wavelength in optical lithography according to advance in miniaturization of a semiconductor device. In such a pattern transfer of a fine region, however, since influence of light diffraction significantly appears, a contour of a mask pattern is not formed on a wafer as it is, which results in considerable degradation in shape accuracy such as rounding of a corner of the pattern or shortening of a length of the pattern. Therefore, the mask pattern is designed with the process of the reverse-correction so that this deterioration may become small. The process is called “optical proximity correction” (hereinafter, abbreviated as “OPC”).

In a conventional OPC, the correction is performed with a rule base or a model base using optical simulation, while taking into account the influence of a shape of a figure and its surrounding pattern for each figure in a mask pattern. Japanese Patent Application Laid-Open Publication No. 2002-303964 (Patent Document 3) describes a rule base OPC that performs graphical operation according to a line width and a space width between adjacent lines to conduct pattern correction. Also, Japanese Patent Application Laid-Open Publication No. 2001-281836 (Patent Document 2) describes a rule base OPC that performs line segment vectorization process and line segment sorting process to calculate a line width and a space width and performs pattern correction with reference to a correction table using hash function. Further, Japanese Patent Application Laid-Open Publication No. 2004-61720 (Patent Document 4) describes a model base OPC that takes in a process effect through a transfer experiment.

In the model base using optical simulator, a mask pattern is continuously changed until a desired transfer pattern is obtained, and various methods to acquire the desired mask pattern have been proposed. For example, a so-called sequential improving process has been known in which, when an optical image is partially thick, the corresponding pattern is made thin, and when the optical image is thin, it is made thick, and the optical image is re-calculated in such a state, thereby gradually approaching its desired shape. A method of gradually approaching its desired shape by using a genetic algorithm has also been proposed. In the method using a genetic algorithm, a pattern is divided into a plurality of line segments and displacement of the line segments is assigned as a displacement code. Then, the displacement code is regarded as a chromosome to compute evolution of inheritance, thereby gradually approaching its desired optical image. An optimization method for the OPC using the genetic algorithm is described in Japanese Patent No. 3512954 (Patent Document 1).

Japanese Patent Application Laid-Open Publication No. 2002-328457 (Patent Document 5) describes a method where graphic is changed for each portion of a mask layout instead of the whole mask layout. In the procedure of the method, first, regarding each of target cells to be corrected included in design layout data, an environment profile expressed in a specific form is determined according to whether or not another graphic is present around the target cell. Then, a replacement cell name which is a name of a correction pattern to be replaced in accordance with the determined environment profile is read with reference to a cell replacement table, and corrected layout data is produced. Finally, a correction pattern corresponding to the read replacement cell name is taken from a cell library to produce mask data representing the completion of correction.

### SUMMARY OF THE INVENTION

The inventors of the present invention have examined the mask pattern designing technology described above and have found the following facts.

In the method described in Patent Document 5, for example, regarding all environment profiles which can be assumed for the target cells to be corrected, it is necessary to determine optimal correction patterns to be replaced, give replacement cell names to respective correction patterns and store the environment profiles and replacement cell names associated with each other in a cell replacement table in advance. Therefore, such a problem arises that cost required for advance preparation increases and much storage region is required.

The genetic algorithm (hereinafter, also referred to as “GA”) is a search technique utilizing a population genetics model, and it is known to have such an excellent performance to find good solution quickly without depending on a target problem. As the reference document for the GA, there is “Genetic Algorithms in Search, Optimization, and Machine Learning” by David E. Goldberg, published by ADDISON-WESLEY PUBLISHING COMPANY, INC. in 1989 (Non-Patent Document 1), for example.

In the GA, solution candidates for the search problem are expressed using bit a string called “chromosome”, and character string operation is preformed to a population constituted of a plurality of chromosomes, thereby causing the battle for survival. Respective chromosomes are evaluated by an objective function which is a search problem itself, and the result of the evaluation is calculated as fitness which is a scalar value. A chromosome having high fitness is given an opportunity for leaving many descendants. Further, a new chromosome is produced by performing crossover between chromosomes within a population, and mutation. By repeating such a process, a chromosome having higher fitness is produced, and chromosome having the highest fitness constitutes a final solution.

FIG. 1 is a flowchart showing the most fundamental calculation procedure in the GA. An object and an outline of each process are as follows:

Initialization (step S02): A plurality of chromosomes as solution candidates are generated at random and a population is formed. An optimization problem to be solved is expressed as an evaluation function returning a scalar value.

Evaluation of chromosomes (step S03): Chromosomes are evaluated using the evaluation function and fitness of each chromosome is calculated.

Generation of next-generation population (step S04): A chromosome with higher fitness is given an opportunity that can leave more descendants by using genetic operation (gene selection, crossover, and mutation).

Search termination criterion determination (step S05): Evaluation of chromosomes and generation of next-generation population are repeated until given conditions are satisfied.

Outline of the genetic algorithm will be described below with reference to FIG. 1.

In the “initialization” in step S02, “definition of chromosome expression”, “determination of evaluation function”, and “generation of initial chromosome population” are performed.

In the “definition of chromosome expression”, contents of data and form thereof to be transmitted from a chromosome of a parent to a chromosome of a descendant at the generation alternation are defined. FIG. 2 shows one example of a chromosome. In FIG. 2, respective elements xi (i=1, 2, . . . , D) of D-dimensional variable vectors X=(X₁, X₂, . . . , X_{D}) expressing the points in a solution space for a target optimization problem are expressed using a string constituted of M symbols Ai (i=1, 2, . . . , M), which is regarded as a chromosome constituted of D×M genes. A set of certain integers, actual values in a certain range, a symbol string, or the like can be used as values Ai of genes according to the property of a problem to be solved. FIG. 2 shows one example where, regarding one of solution candidates of an optimization problem corresponding to five dimensions or five variables (namely, D=5), each variable is expressed using four symbols (namely, M=4) of two kinds (0, 1). A gene string thus symbolized is a chromosome.

Next, in “determination of evaluation function”, a calculation method of a fitness representing a degree of adaptation of each chromosome to environment is defined. At that time, such a design is adopted that fitness of a chromosome corresponding to a variable vector excellent as a solution of an optimization problem to be solved becomes higher.

In “generation of initial chromosome population”, N chromosomes are generated according to a rule determined in “definition of chromosome expression” at random. This is because property of the optimization problem to be solved is unclear and kind of a superior chromosome is unclear at all. However, when there is any priori knowledge regarding the problem, the accuracy and search speed can be improved in some cases by generating a chromosome population centering on a region where fitness is expected to be high in a search space.

In “evaluation of chromosomes” in step S03, fitness of each chromosome in the population is calculated based upon the method defined in the “determination of evaluation function” step.

In “generation of next-generation population” in step S04, the genetic operation is performed to the chromosome population based upon the fitness of each chromosome to generate a chromosome population of next generation. The major procedures of the genetic operation include gene selection, crossover, mutation, and the like, which are collectively called “genetic operation”.

In the “selection” step, a chromosome with high fitness is extracted from a current generation chromosome population to be left for the next-generation population, and on the other hand, chromosomes with low fitness are eliminated.

In the “crossover” step, chromosome pairs are selected at random from a population of chromosomes extracted by the selection with a predetermined probability to recombine some of the chromosomes, thereby producing new chromosomes.

In the “mutation” step, chromosomes are selected at random from a population of chromosomes extracted by the selection with a predetermined probability and genes are changed with a predetermined probability. Note that a probability of occurrence of mutation is called “mutation rate”.

In the “search termination criterion determination” in step S05, it is determined whether or not the next-generation chromosome population generated satisfies a criterion for terminating the search. When the criterion is satisfied, the search is terminated, and the chromosome with the highest fitness at this time in the chromosome population is determined as a solution for the optimization problem to be obtained. When the termination criterion is not satisfied, the process is returned back to the “evaluation of chromosomes” step, where the search is continued. The termination criterion of the search process depends on characteristics of the optimization problem to be solved but it typically includes the following conditions.
(a) The maximum fitness in a chromosome population exceeds a certain threshold.
(b) An average fitness of chromosomes in a whole chromosome population exceeds a certain threshold.
(c) An increase rate of fitness in a chromosome population is equal to or lower than a certain threshold continues for a fixed period or more.
(d) The number of generation alternations reaches a predetermined number of times.

In the conventional method utilizing the above-described genetic algorithm, OPC is performed to all figures of a mask defining a circuit pattern of a semiconductor chip if necessary. Therefore, according to increase of the number of figures due to miniaturization, a processing time for OPC significantly increases. In an actual case, several tens hours are required for a 90 nm node device. Also, due to the reduction of exposure contrast caused by forming a pattern at an extreme resolution for the exposure, OPC becomes more complicated and more figures are required in the case of further miniaturization. A time required for producing the mask pattern of a 65 nm node device extends over several days in some case. On the other hand, since a product cycle of a semiconductor device becomes short, the reduction of the OPC processing time is an extremely serious problem to be solved.

Increase of the OPC processing time deteriorates a manufacture TAT (Turn Around Time) of a semiconductor device including a mask pattern generation, and it also causes increase in cost.

In view of these circumstances, an object of the present invention is to provide a mask pattern designing technology which comprises an OPC process which can achieve the reduction in an increasing OPC processing time, reduce a manufacture TAT for a semiconductor device, and reduce the cost.

Another object of the present invention is to provide a manufacturing technology of an electronic circuit device and a semiconductor device capable of generating the mask pattern within a practical time period to reduce a manufacturing period.

The above and other objects and novel characteristics of the present invention will be apparent from the description of this specification and the accompanying drawings.

The typical ones of the inventions disclosed in this application will be briefly described as follows.

The OPC process is performed for a cell library pattern which forms a basic configuration of a semiconductor circuit pattern in advance, and a semiconductor chip is manufactured using the OPC-processed cell library pattern subjected to the OPC process. At this time, since the cell library pattern subjected to the OPC process in advance is influenced by a cell library pattern positioned around the OPC-processed cell library pattern, correction process (optimization process) is performed. As one method, the correction process is performed by genetic algorithm based upon a degree of influence from a surrounding pattern taken in advance. Since the optimization means such as a genetic algorithm is superior as a method for performing optimization of an enormous number of combinations at high speed, speed-up of the correction process is achieved by utilizing the means, and the OPC processing time can be reduced as compared with the conventional whole pattern OPC process. This is because GA can reduce the number of steps for achieving a desired value and it is suitable for parallel processing.

Further, a cell group where arrangements of the cells including the target cell and its surrounding cells are the same is extracted and it is registered as a cell set, and a similar cell set is produced by copying without re-calculating the OPC of a cell boundary portion therein. That is, a pattern group with the same arrangement is produced by copying. By this means, the number of steps can be significantly reduced and a processing time can be also significantly reduced.

The effects obtained by typical aspects of the present invention will be briefly described below.

(1) The OPC process is first performed for each cell and the OPC-processed cells are stored, and all figures on a mask are formed using the combinations of the stored cells. Then, OPC adjustment process between cells is performed for all the figures on the mask. By this means, the processing time can be significantly reduced.

(2) Since pattern groups having the same arrangement are produced by copying, the number of steps and a processing time can be significantly reduced.

(3) A proximity correction processing system can be made compact and its cost can also be reduced.

(4) Since the same arrangement is searched in each cell, a process for searching patterns with the same arrangement is facilitated, which contributes to the reduction in processing time.

(5) A mask pattern designing for a large scale integrated circuit in a method of manufacturing a semiconductor device is speeded up and facilitated. Consequently, a mask pattern can be produced at a high speed and at low cost.

### BRIEF DESCRIPTIONS OF THE DRAWINGS

FIG. 1 is a flowchart showing a processing procedure of a genetic algorithm examined prior to the present invention;

FIG. 2 is a diagram showing one example of expression of a chromosome used in an OPC processing method examined prior to the present invention;

FIG. 3 is a diagram showing a mask pattern used for a gate in an SRAM in a first embodiment of the present invention;

FIG. 4 is a diagram showing mask patterns used for the verification in the present invention in the first embodiment of the present invention;

FIG. 5 is a diagram showing a transfer pattern example and measurement portions of the mask pattern shown in FIG. 4;

FIG. 6 is a diagram showing exposure pattern examples of P1 and P3 in the mask pattern shown in FIG. 4;

FIG. 7 is an enlarged view of P3 in the mask pattern shown in FIG. 4;

FIG. 8 is an enlarged view of P1 in the mask pattern shown in FIG. 4;

FIG. 9 is a diagram showing portions of parameters for optimizing exposure patterns of P1 and P3 in the mask pattern shown in FIG. 4;

FIG. 10A is a symbol diagram of a NAND gate in a second embodiment of the present invention;

FIG. 10B is a circuit diagram of the NAND gate shown in FIG. 10A;

FIG. 10C is a plan view showing a pattern layout of the NAND gate shown in FIG. 10A;

FIG. 11 is a diagram showing a unit logic cell and a broken line defining a section in the NAND gate shown in FIG. 10A to FIG. 10C;

FIG. 12A is a diagram showing a mask used for forming a unit cell portion of the NAND gate shown in FIG. 10A to FIG. 10C;

FIG. 12B is a diagram showing a mask used for forming a unit cell portion of the NAND gate shown in FIG. 10A to FIG. 10C;

FIG. 12C is a diagram showing a mask used for forming a unit cell portion of the NAND gate shown in FIG. 10A to FIG. 10C;

FIG. 12D is a diagram showing a mask used for forming a unit cell portion of the NAND gate shown in FIG. 10A to FIG. 10C;

FIG. 12E is a diagram showing a mask used for forming a unit cell portion of the NAND gate shown in FIG. 10A to FIG. 10C;

FIG. 12F is a diagram showing a mask used for forming a unit cell portion of the NAND gate shown in FIG. 10A to FIG. 10C;

FIG. 13A is a process drawing showing a step of forming a device isolation in a section taken along a broken line shown in FIG. 11;

FIG. 13B is a process drawing showing a step of forming a device isolation in a section taken along a broken line shown in FIG. 11;

FIG. 13C is a process drawing showing a step of forming a device isolation in a section taken along a broken line shown in FIG. 11;

FIG. 13D is a process drawing showing a step of forming a device isolation in a section taken along a broken line shown in FIG. 11;

FIG. 13E is a process drawing showing a step of forming a device isolation in a section taken along a broken line shown in FIG. 11;

FIG. 14A is a process drawing showing a gate formation step in a section taken along the broken line shown in FIG. 11;

FIG. 14B is a process drawing showing a gate formation step in a section taken along the broken line shown in FIG. 11;

FIG. 14C is a process drawing showing a gate formation step in a section taken along the broken line shown in FIG. 11;

FIG. 14D is a process drawing showing a gate formation step in a section taken along the broken line shown in FIG. 11;

FIG. 14E is a process drawing showing a gate formation step in a section taken along the broken line shown in FIG. 11;

FIG. 15A is a process drawing showing a step of forming some wires in a section taken along the broken line shown in FIG. 11;

FIG. 15B is a process drawing showing a step of forming some wires in a section taken along the broken line shown in FIG. 11;

FIG. 15C is a process drawing showing a step of forming some wires in a section taken along the broken line shown in FIG. 11;

FIG. 15D is a process drawing showing a step of forming some wires in a section taken along the broken line shown in FIG. 11;

FIG. 15E is a process drawing showing a step of forming some wires in a section taken along the broken line shown in FIG. 11;

FIG. 16 is a diagram showing a structure of a mask pattern shown in FIG. 12D;

FIG. 17 is a diagram showing one example of gene expression of difference sizes from a design target in FIG. 16;

FIG. 18 is a diagram showing an example of a grouping of cells performed based upon a relative position in the second embodiment of the present invention;

FIG. 19 is a diagram showing a portion where size is measured in order to obtain fitness of a chromosome in the second embodiment of the present invention;

FIG. 20 is a diagram showing a difference image between a design pattern and a resist pattern in the second embodiment of the present invention;

FIG. 21 is a flowchart showing a semiconductor device manufacturing process in a third embodiment of the present invention;

FIG. 22 is a diagram showing a cell, to which OPC for single cell is performed, in a cell library in a fourth embodiment of the present invention;

FIG. 23 is an enlarged view of the cell shown in FIG. 22;

FIG. 24 is a diagram showing one example of an adjustment variable of a gate width w1 in the fourth embodiment of the present invention;

FIG. 25 is a diagram showing one example of an adjustment variable of alignment margins d1 and d2 between a contact and a diffusion layer in the fourth embodiment of the present invention;

FIG. 26 is a diagram showing one example of avoidance of resolution failure (pattern connection failure) between adjacent cells in the fourth embodiment of the present invention;

FIG. 27 is a diagram showing one example of avoidance of riding failure of gate wire over a diffusion layer in the fourth embodiment of the present invention;

FIG. 28 is a diagram showing portions of the OPC figures of gate length, an avoidance margin of resolution failure (pattern connection failure) between adjacent cells s4, an avoidance margin of riding failure of a gate wire over a diffusion layer s3, and a projecting amount from an active region p1 in the fourth embodiment of the present invention;

FIG. 29A is a diagram showing one example of an adjustment variable of a gate length in the fourth embodiment of the present invention;

FIG. 29B is a diagram showing one example of an adjustment variable of a gate length in the fourth embodiment of the present invention;

FIG. 30 is a diagram showing one example of avoidance of resolution failure (pattern connection failure) between adjacent cells in the fourth embodiment of the present invention;

FIG. 31 is a diagram showing one example of avoidance of riding failure of gate wire over a diffusion layer in the fourth embodiment of the present invention;

FIG. 32A is a diagram showing one example of correction of projection from an active region in the fourth embodiment of the present invention;

FIG. 32B is a diagram showing one example of correction of projection from an active region in the fourth embodiment of the present invention;

FIG. 32C is a diagram showing one example of correction of projection from an active region in the fourth embodiment of the present invention;

FIG. 33 is a diagram showing a layout example of a contact layer in the fourth embodiment of the present invention;

FIG. 34 is a diagram showing one example of an adjustment variable of a contact pattern in the fourth embodiment of the present invention;

FIG. 35 is a flowchart showing a processing procedure of a cell set method in a fifth embodiment of the present invention;

FIG. 36 is an explanatory diagram showing a concept of a cell set in the fifth embodiment of the present invention;

FIG. 37 is an explanatory diagram showing a concept of a cell set in the fifth embodiment of the present invention;

FIG. 38 is a table showing lithography conditions in the first embodiment of the present invention;

FIG. 39 is a table showing two evaluation values of the transfer pattern shown in FIG. 4; and

FIG. 40 is a table showing the result where the parameter shown in FIG. 9 has been optimized.

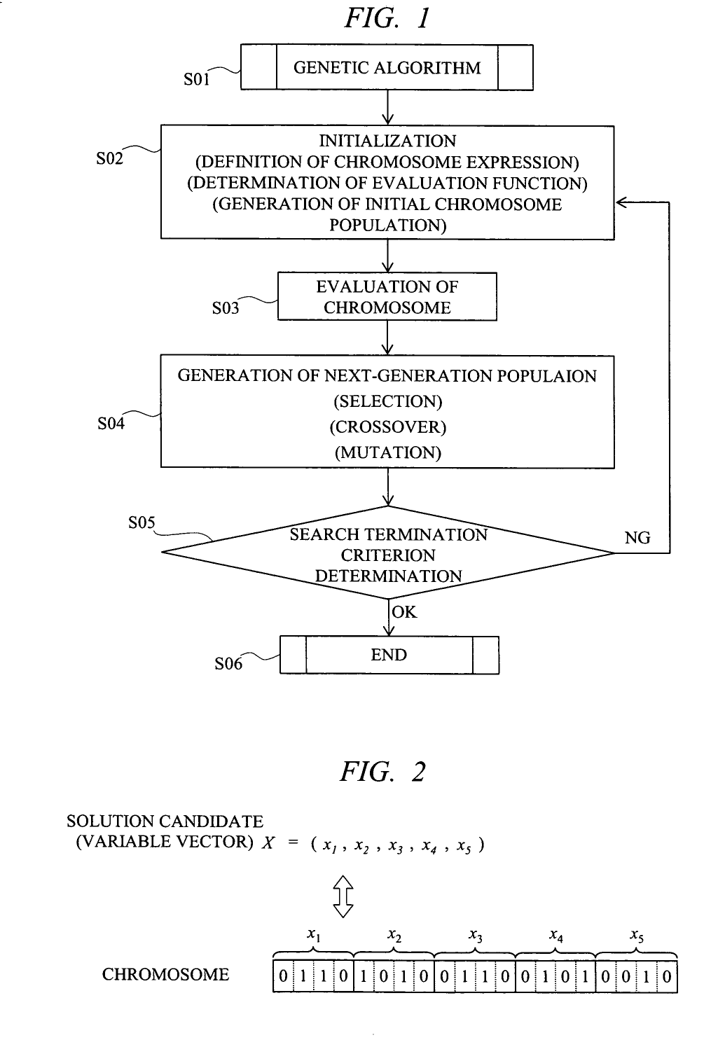

### DESCRIPTIONS OF THE PREFERRED EMBODIMENTS

Hereinafter, embodiments of the present invention will be described in detail with reference to the accompanying drawings. Note that components having the same function are denoted by the same reference symbols throughout the drawings for describing the embodiment, and the repetitive description thereof will be omitted.

(First Embodiment)

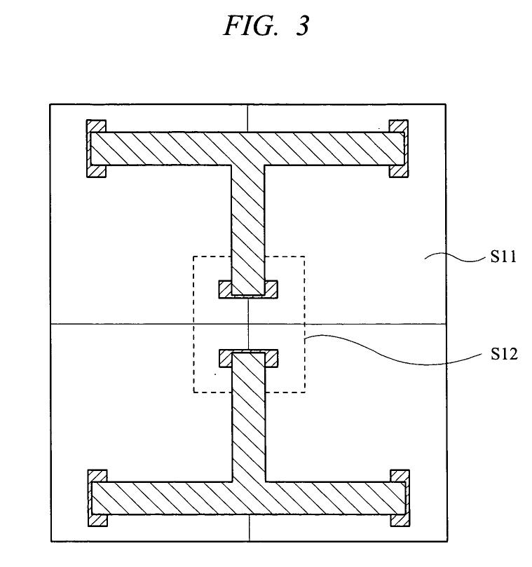

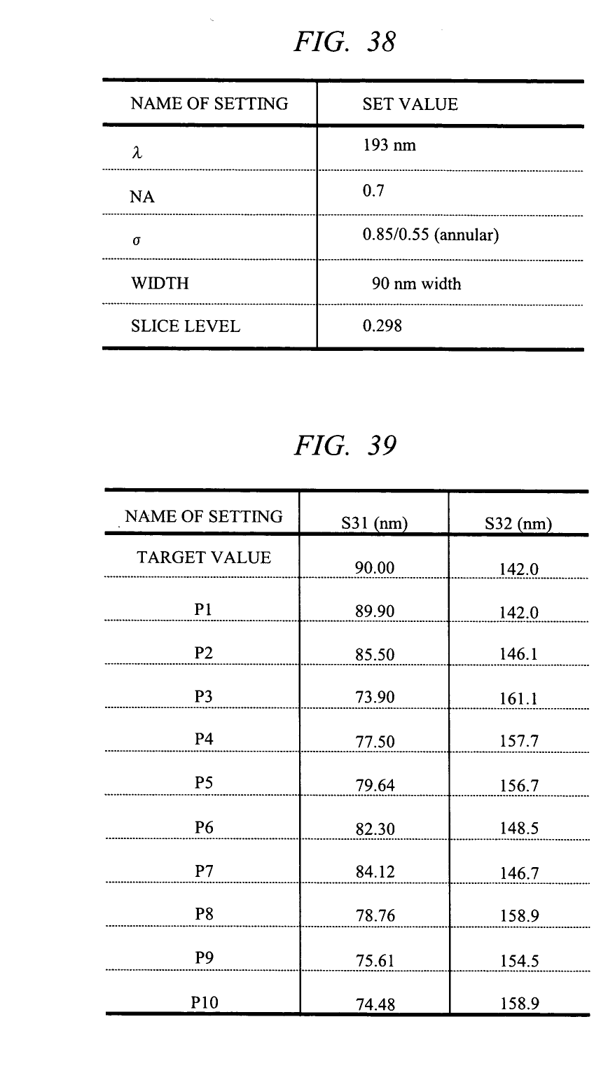

A mask pattern according to a first embodiment of the present invention is designed using a computer or the like. In order to verify effectiveness of the present invention, one of mask patterns used for a gate of an SRAM shown in FIG. 3 is defined as one cell and the present invention is applied thereto. First, a verification experiment whether or not transfer of mask patterns is influenced by an ambient environment is performed. Next, a pattern designing technique using a genetic algorithm which is a technique of the present invention is applied to a most influenced pattern of the mask patterns, and it is determined through a verification experiment whether optimization can be performed. In the experiments described below, verification is performed under such lithographic conditions as shown in FIG. 38.

The transfer pattern described above is generated by optical simulation software. As the software, for example, “SOLID-C” (trademark) available from Litho Tech Japan Corporation is known and is well-known by those skilled in the art (URL; http://www.ltj.co.jp/index.html).

[Verification Experiment 1]

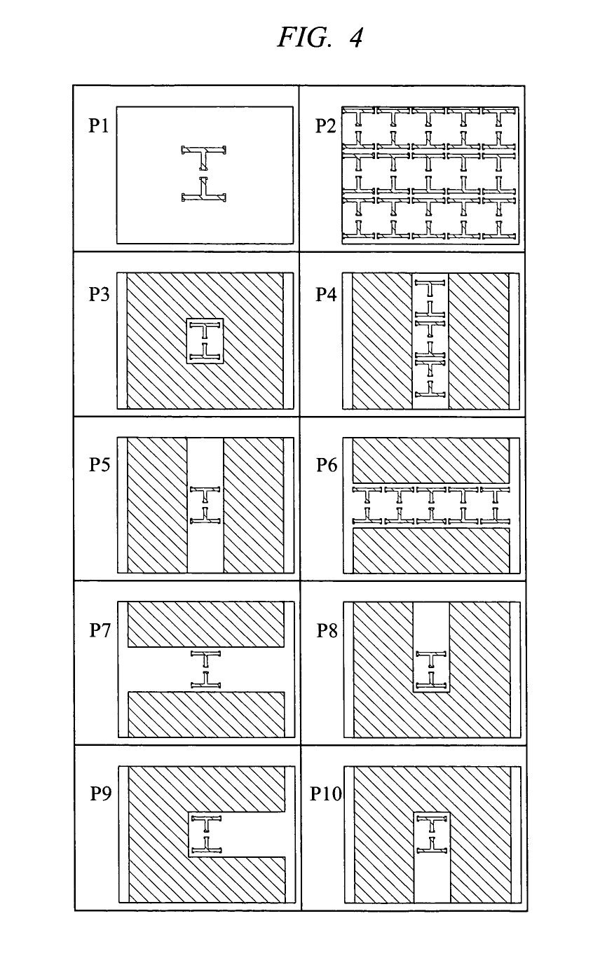

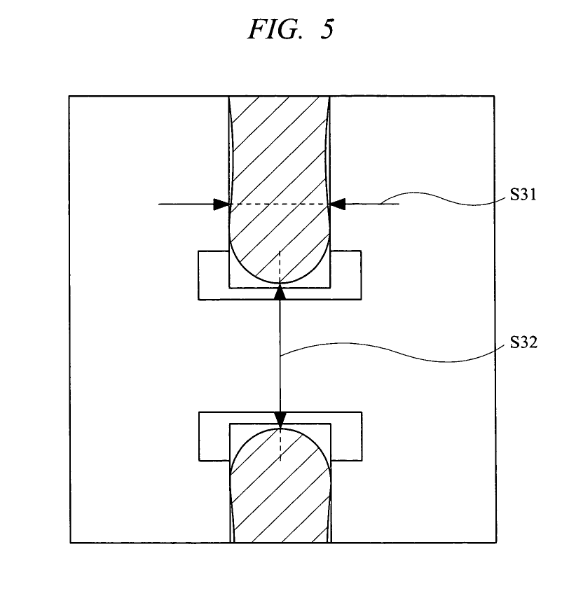

First, a verification experiment whether or not mask. patterns are influenced according to difference in ambient environment is performed. Mask patterns used for the verification are shown in FIG. 4. Since each of the 10 patterns is designed to have a width of 90 nm, an ideal line width is 90 nm. In this experiment, these transfer patterns are formed and two values of lengths of a width A (S31) and a gap B (S32) shown in FIG. 5 (corresponding to an enlargement of a portion S12 in FIG. 3) are compared with each other as evaluation values. By doing so, the influence of ambient environment is verified.

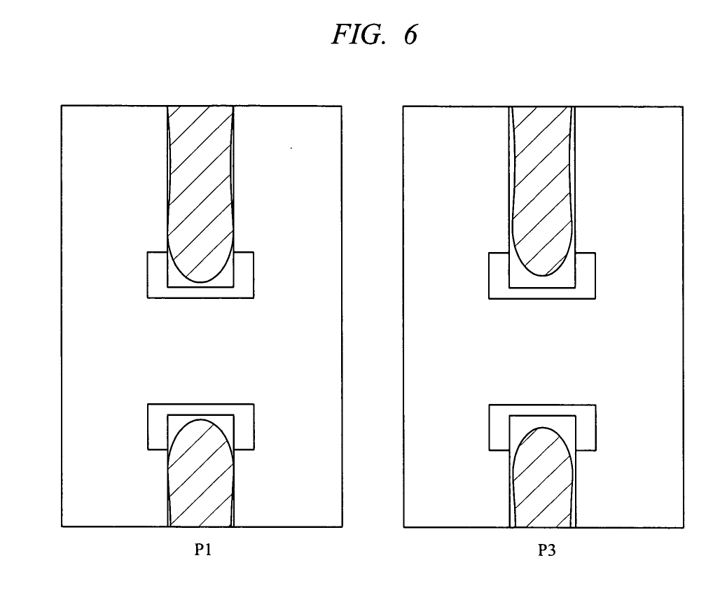

FIG. 39 shows two evaluation values of transfer patterns of all patterns shown in FIG. 4. In a pattern P1, since a transfer pattern is not influenced by an ambient environment at all, an ideal line width can be obtained. In patterns P2, P3, and others, it is understood from comparison with the pattern P1 that a transfer pattern is largely influenced by an ambient environment and a line width S31 and a gap S32 are largely deviated from target values. FIG. 6 shows transfer patterns of the most influenced pattern P3 and the ideal pattern P1. It is understood that the transfer pattern of the pattern P3 has been influenced in not only its line width S31 and gap S32 but also its whole shape. It is also understood from comparison of evaluation values of other patterns that a degree of incidence to a transfer pattern varies according to a difference of an ambient environment. Since various cells are combined for use in an actual mask pattern, it can be anticipated that the influence of ambient environment becomes very large and complicated. Accordingly, it is indispensable to perform complicated optimization of an OPC mask in accordance with an ambient environment even in mask patterns with the same design.

[Verification Experiment 2]

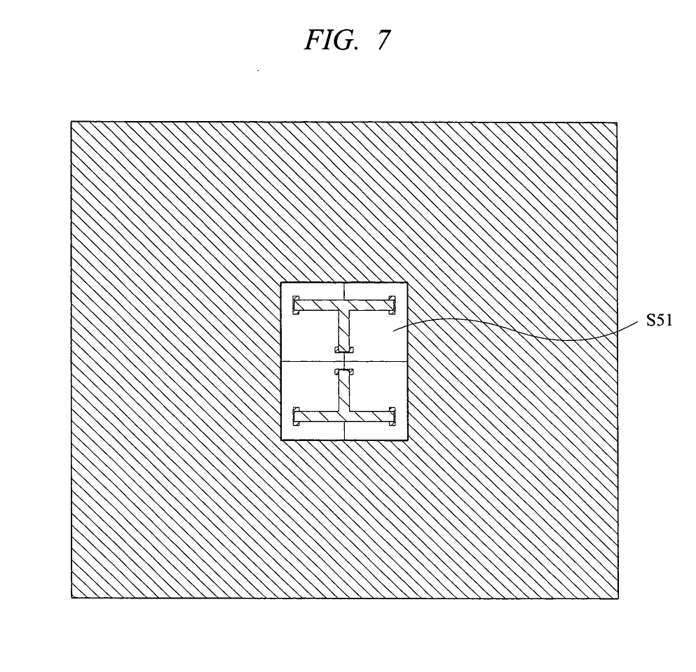

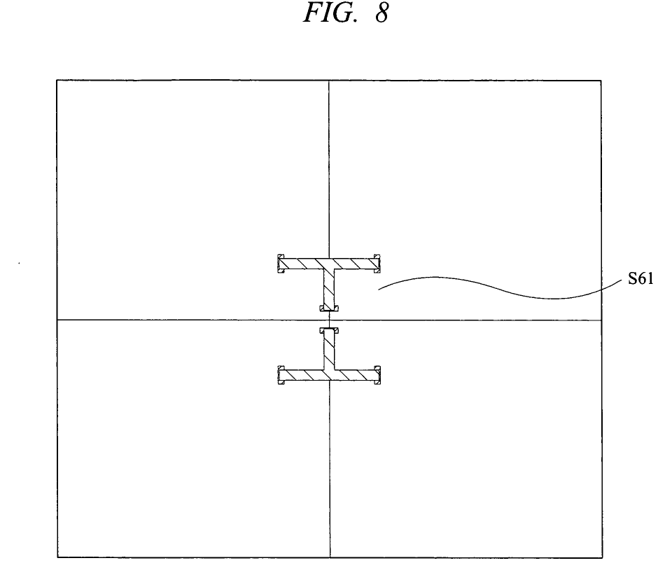

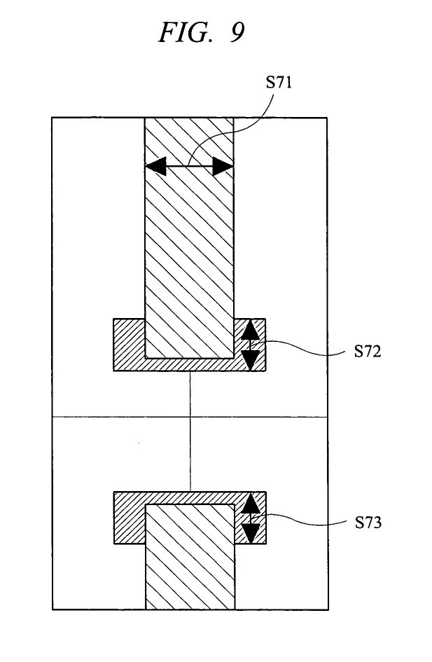

In a verification experiment 2, it is verified whether or not influence from an ambient environment demonstrated in the verification experiment 1 can be solved by the technique of the present invention. In the verification experiment 2, a simulation for optimizing the pattern P3 (FIG. 7) which is the most influenced pattern in the verification experiment 1 toward the pattern P1 (FIG. 8) which is closest to an ideal pattern is performed as the simplest example. In this simulation, optimization is performed according to the technique of the present invention with using two portions S71 and S72 in a cell shown in FIG. 9 (corresponding to an enlargement of a transfer pattern of S12 in FIG. 3) as optimization parameters.

An application method of the genetic algorithm will be described below. Since a calculation procedure of the genetic algorithm is the same as that described in the “Summary of the Invention”, details of respective steps will be described here.

[Initialization: Definition of Chromosome Expression]

In this simulation, since S71 and S72 shown in FIG. 9 are used as optimization parameters, a variable vector X is regarded as a two-dimensional vector such as X=(x1, x2) and respective elements xi (i=1, 2) are expressed by real numbers. Incidentally, it is assumed that S73 always takes a value equal to that of S72.

[Initialization: Determination of Evaluation Function]

Since fitness cannot be defined using an explicit function, a procedure of fitness calculation constituted of four steps is adopted as described below.

Step (1): A figure pattern is reconstructed using a variable vector defined from a chromosome uniquely.

Step (2): An optical simulation is performed, and an exposure pattern is calculated.

Step (3): Regarding the calculated exposure pattern, sizes of S31 and S32 shown in FIG. 5 are measured and a sum of errors from design values is calculated.

Step (4): Since a target to be achieved here is to obtain an exposure pattern as close to the design value as possible, smaller errors are more preferable. Therefore, a reciprocal of the measured sum of errors is defined as fitness.

[Initialization: Generation of Initial Chromosome Population]

A vector constituted of two real number value elements is here defined as a chromosome according to the rule determined in the above “Initialization: Definition of Chromosome expression”. It is assuming that the number N of chromosomes is 100, and 100 chromosomes are generated at random using a pseudorandom number generator.

[Evaluation of Chromosome]

All chromosomes are evaluated according to the evaluation procedure of chromosome determined in the above “Initialization: Determination of Evaluation Function” and fitness is calculated.

[Generation of Next-Generation Population: Selection]

In the first embodiment, a roulette selection is used. In this method, a probability that each chromosome can live in the next generation is proportional to its fitness. That is, a chromosome with a higher fitness is arranged in more pockets in the roulette, and a hit probability when the roulette is rotated becomes higher correspondingly. More specifically, when a size of a chromosome population is represented as N, fitness of i-th chromosome is represented as Fi, and a total sum of fitnesses of all the chromosomes is represented as Σ, a procedure for extracting each chromosome with a probability of (Fi÷Σ) is repeated N times for the selection. In the above-described case, since the number of chromosomes is 100, 100 next-generation chromosomes are selected by repeating the procedure 100 times.

[Generation of Next-Generation Population: Crossover]

In the first embodiment, a uniform crossover is used. In this method, two chromosomes are selected from each chromosome population to make determination whether or not variables which are genes are exchanged in each gene locus at random. More specifically, two selected chromosomes are defined as X¹=(x¹₁, x¹₂) and X²=(x²₁, x²₂) and random number generation for outputting 0 or 1 with a probability of 1/2 is performed twice. The first random number is directed to the first gene locus and when it is 1, x¹₁ and x²₁ are exchanged, and when it is 0, exchange is not performed. Process to the second gene locus is performed in the same manner.

[Generation of Next-generation Population: Mutation]

The first embodiment adopts a process where a random number generated according to a normal distribution is added to a gene locus selected at a mutation rate P_{M}. In this case, the mutation rate P_{M}, an average u of the normal distribution, and the standard deviation σ are set to 1/50, 0, and 5×10⁹, respectively.

[Termination Criterion of Search]

In the first embodiment, when a chromosome where an error from a design value is zero has been found or when evaluation of chromosome has been performed 5000 times, the search is terminated.

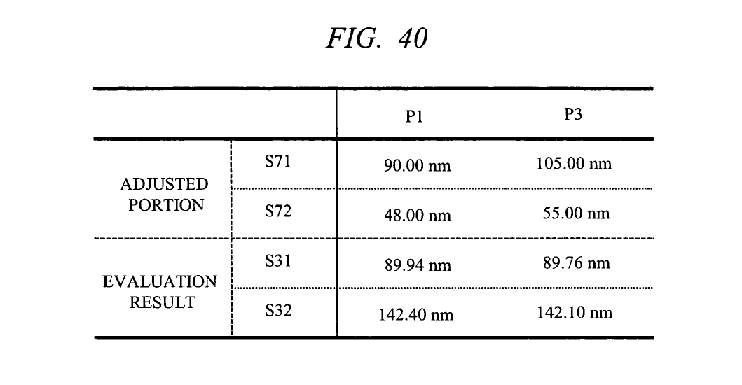

In the verification experiment using the genetic algorithm described above, a result shown in FIG. 40 is obtained by optimizing the parameters shown in FIG. 9. As is apparent from FIG. 40, it is understood that the width S31 of the transfer pattern reduced by about 16 nm in the ambient environment shown in FIG. 7 as shown in FIG. 39 corresponding to the verification experiment 1 is optimized to about 90 nm close to an ideal width shown in FIG. 8 according to the technique of the present invention.

It is confirmed through the experiment described above that deviation of a transfer pattern due to influence from an ambient environment in a mask pattern design can be optimized by the technique of the present invention.

In the first embodiment, the case of using a simple sum of errors in S31 and S32 has been described. Though the simple sum is available for various cases, the method of using the weight value depending on level of importance of a portion may be adopted. For example, when it is important to control a size of the line width S31 to be a gate, accuracy of a required portion is relatively increased by multiplying a value of S32 by such a factor of 2 or 3.

(Second Embodiment)

Another example where a semiconductor integrated circuit device is manufactured using a mask designed by the mask pattern designing method according to the present invention will be described.

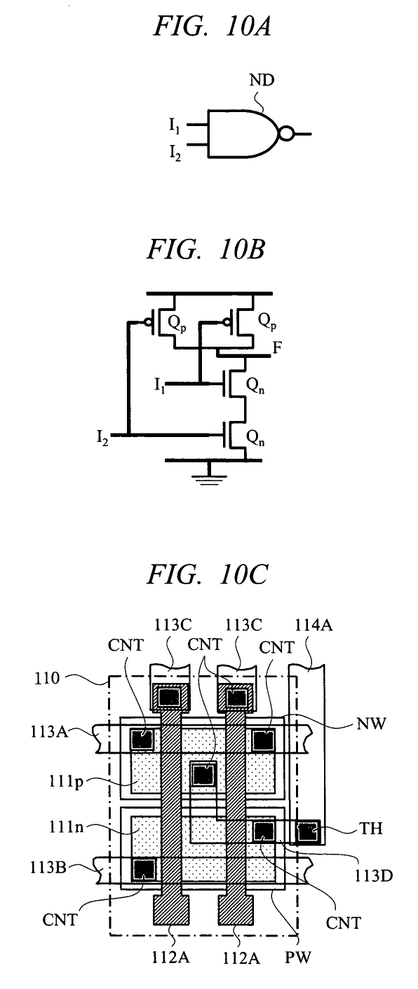

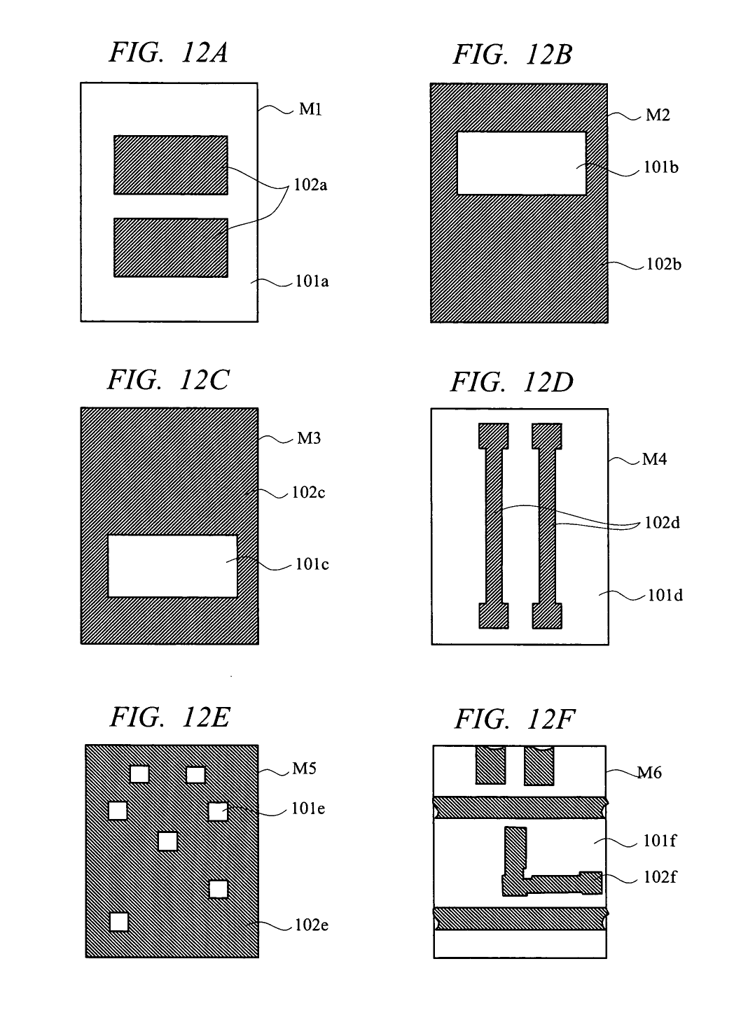

FIG. 10A is a symbol diagram of a two input NAND gate circuit ND, FIG. 10B is a circuit diagram of the two input NAND gate circuit ND shown in FIG. 10A, and FIG. 10C is a plan view showing a layout of the two input NAND gate shown in FIG. 10A. In FIG. 10C, a portion surrounded by a one-dotted chain line is a unit cell 110, which is constituted of two n type MOS portions Qn formed on an n type semiconductor region 111n on a surface of a p type well region PW and two p type MOS portions Qp formed on a p type semiconductor region 111p on a surface of an n type well region NW. In order to manufacture the structure, masks M1 to M6 as shown in FIG. 12 are sequentially used to repeatedly perform the pattern transfer utilizing a normal photolithography. Since the masks M1 to M3 of these masks have relatively large-size patterns, the OPC process is not applied to the patterns obtained from them. In FIG. 12, reference numerals 101a, 101b and 101c denote optically transparent portions, and reference numerals 102a, 102b, and 102c denote light shielding portions made from chrome films.

On the other hand, since the masks M4 to M6 have fine patterns, optimization is performed by using the mask pattern designing method according to the present invention to appropriately change a contour or a size of a pattern figure. In FIG. 12, reference numerals 101d, 101e, and 101f denote optically transparent portions, and reference numerals 102d, 102e, and 102f denote light shielding portions.

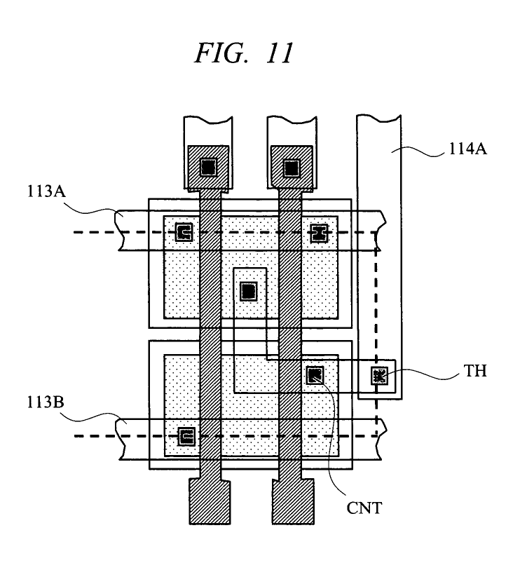

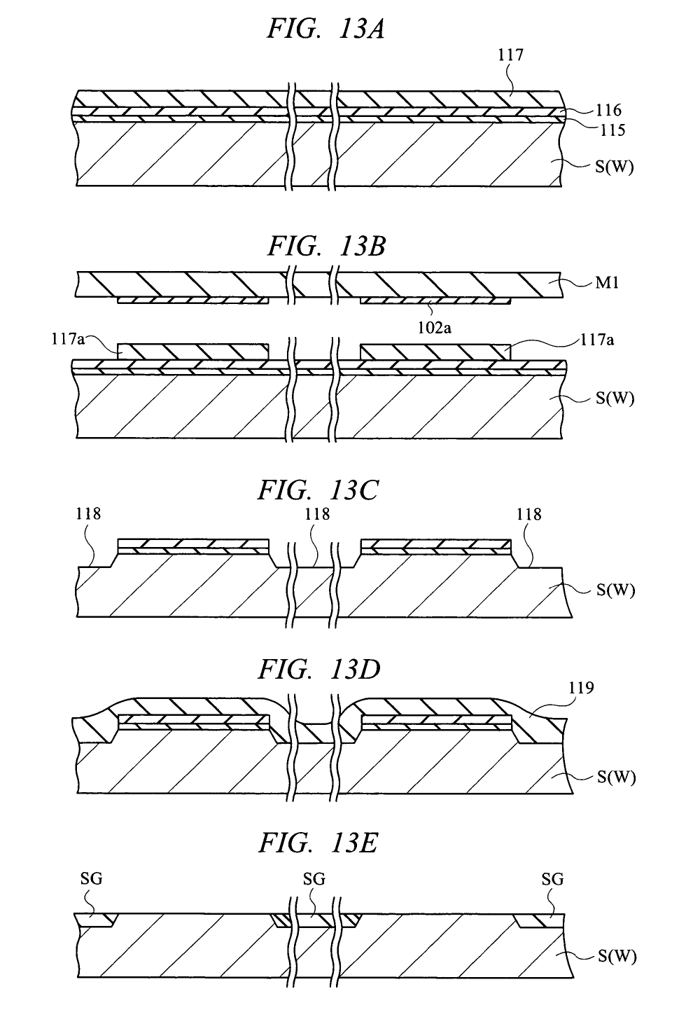

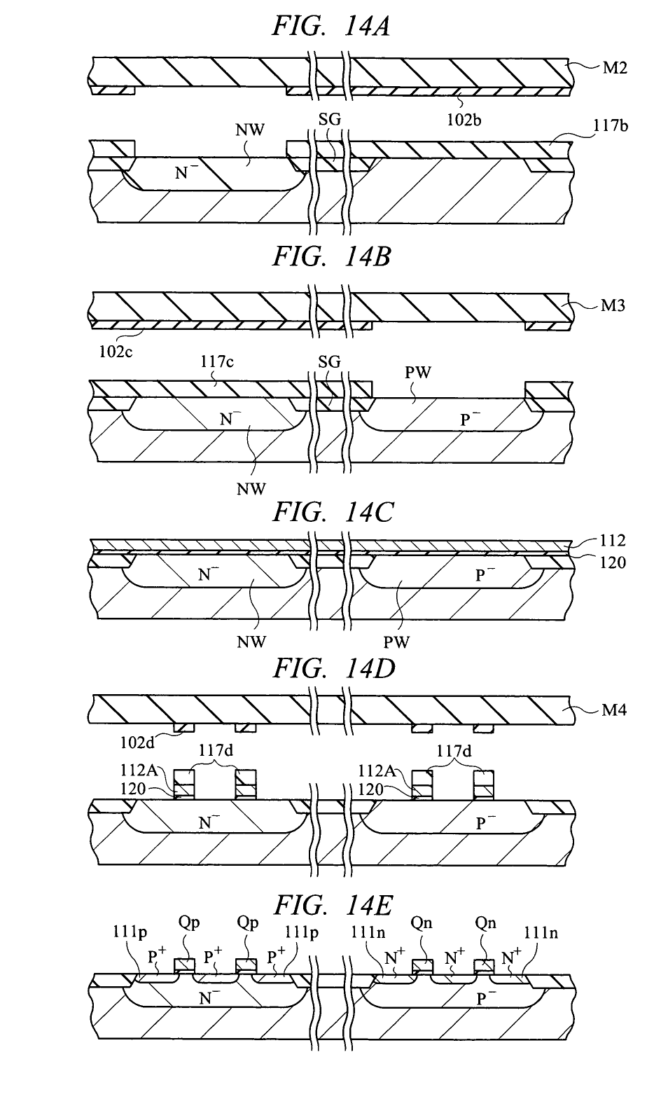

In FIG. 11 representing a layout similar to that in FIG. 10C, a section taken along a broken line is assumed, and steps of forming the channels Qp and Qn are shown using the section in FIG. 13A to FIG. 13E and FIG. 14A to 14E. After an insulating film 115 made of, for example, a silicon oxide film is formed on a wafer S (W) made of P type silicon crystal by an oxidation process, a silicon nitride film 116 is deposited on the insulating film 115 by CVD (chemical vapor deposition) process and a resist film 117 is formed further on the silicon nitride film 116 (FIG. 13A). Next, exposure and development process is performed using the mask M1 to from a resist pattern 117a (FIG. 13B). Thereafter, the insulating film 115 and the silicon nitride film 116 exposed through the resist pattern 117a used as an etching mask are sequentially removed and the resist is further removed. In this manner, trenches 118 are formed on the surface of the wafer S (W) (FIG. 13C). Next, after an insulating film 119 made from, for example, silicon oxide is deposited by CVD process or the like (FIG. 13D), a device isolation structure SG is finally formed by performing planarization process by CMP (chemical mechanical polishing) or the like (FIG. 13E). In the second embodiment, a trench type isolation structure is adopted as the SG, but the present invention is not limited to this structure. For example, the device isolation structure SG may be structured with a field insulating film by, for example, LOCOS (local oxidation of silicon) process.

Subsequently, exposure and development process is performed using the mask M2 to form a resist pattern 117b. Since a region where an n type well region is to be formed is exposed, phosphorus, arsenic, or the like is ion-implanted to form an n type well region NW (FIG. 14A). Similarly, after a resist pattern 117c is formed using the mask M3, boron is ion-implanted to form a p type well region PW (FIG. 14B). Next, a gate insulating film 120 with a thickness of 3 nm made of a silicon oxide film is formed by thermal oxidation process, and a polycrystalline silicon layer 112 is deposited on the gate insulating film 120 by CVD process or the like (FIG. 14C).

Subsequently, after applying a resist, a resist pattern 117d is formed using the mask M4, and a gate insulating film 120 and a gate electrode 112A are formed through the etching of the polycrystalline silicon layer 112 and the resist removal (FIG. 14D). Thereafter, an n type semiconductor region 111n with high impurity concentration for an n channel MOS and a p type semiconductor region 111p with high impurity concentration for a p channel MOS which also function as a source region, a drain region, and a wiring layer are formed for the gate electrodes 112A in a self-aligning manner through ion implantation process or diffusion process (FIG. 14E).

In the subsequent steps, a group of two input NAND gates are formed by appropriately selecting wires. It is needles to say that other circuit such as a NOR gate circuit can be formed by changing the shapes of wires. An example of manufacturing a two input NAND gate using the masks M5 and M6 shown in FIG. 12E and FIG. 12F will be further described here.

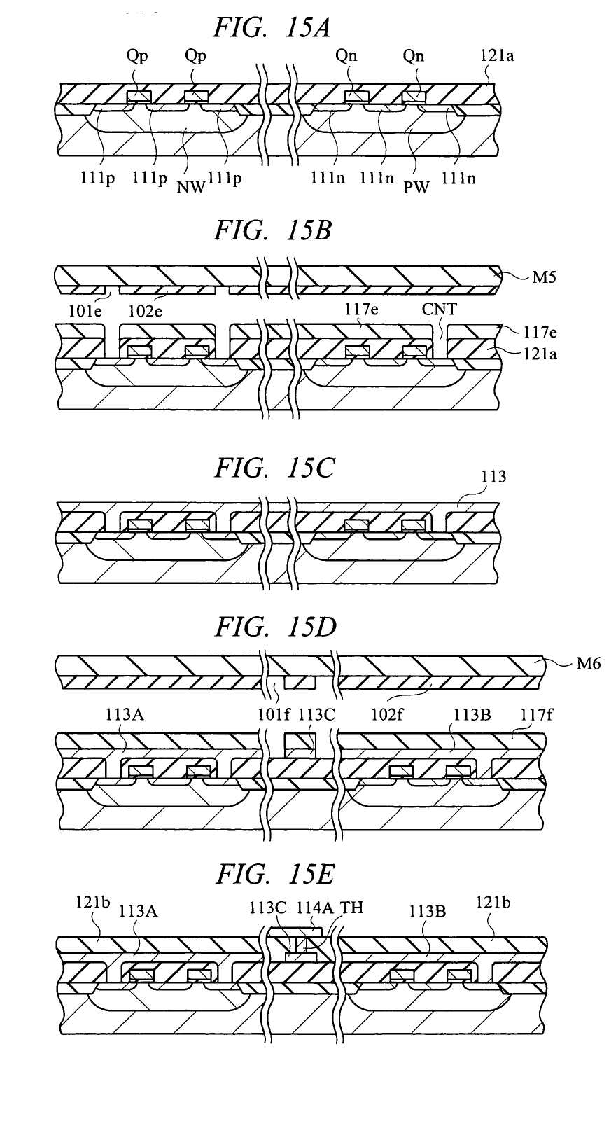

FIG. 15A to FIG. 15E are sectional views taken along a broken line shown in FIG. 11 and illustrate wire forming steps. An interlayer insulating layer, for example, an interlayer insulating film 121a made of a silicon oxide film doped with phosphorus is deposited on the two n channel MOS portions Qn and the two p channel MOS portions Qp by CVD process (FIG. 15A). Subsequently, after applying a resist and forming a resist pattern 117e with using the mask MS, contact holes CNT are formed through etching process (FIG. 15B). After removing the resist, metal such as tungsten, tungsten alloy, or copper is embedded and simultaneously a metal layer 113 made of the metal is formed (FIG. 15C). Subsequently, after applying a resist and forming a resist pattern 117f with using the mask M6, wires 113A to 113C are formed through etching process (FIG. 15D). Thereafter, an interlayer insulating film 121b is formed, and a through-hole TH and an upper layer wire 114a are formed using other masks (not shown) (FIG. 15E). Wire connection between parts is also formed through pattern formation which repeats similar steps by a required number of times, and thus, a semiconductor integrated circuit device is manufactured.

As described above, by applying the method of the present invention, a semiconductor integrated circuit device can be manufactured using masks with high reliability and assured high pattern accuracy.

A light shielding pattern 102d particularly in the mask M4 of the masks constituting the cell library forms a gate pattern with the shortest size, and the accuracy required for a size of a transfer pattern is the most severe. Therefore, when a cell library pattern shown in the mask M4 (FIG. 12) is arranged on a whole surface of a mask, the method of the present invention is adopted.

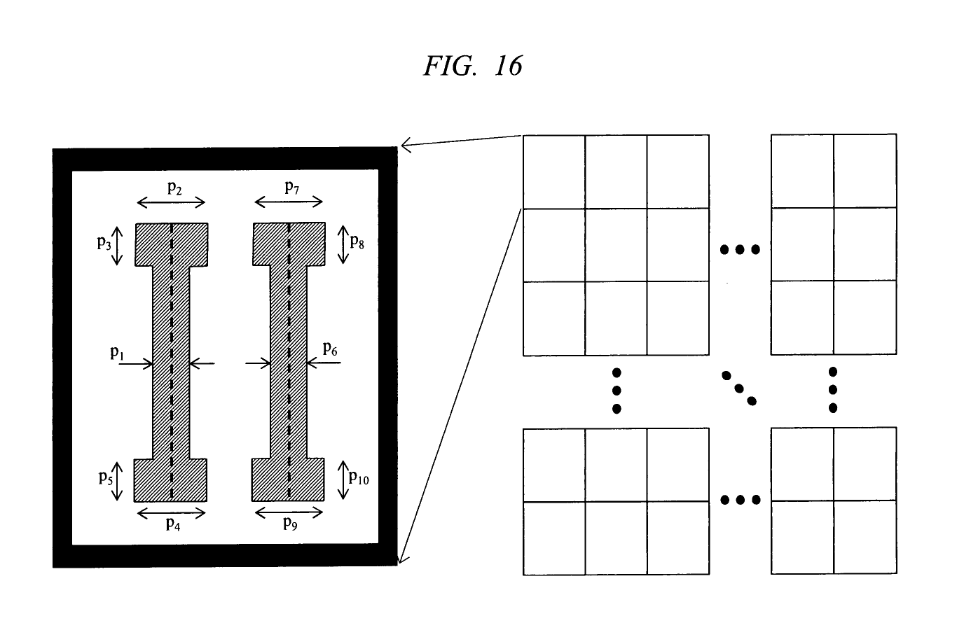

The whole mask pattern is constituted of a plurality of cells, and two I-shaped figures are arranged in each cell (FIG. 16). As shown in FIG. 16, each cell has 10 adjustment portions p1 to p10. Therefore, assuming that the number of cells is N_{cell}, it is necessary to adjust (N_{cell}×10) parameters on the whole mask pattern.

[Initialization: Definition of Chromosome Expression]

In the second embodiment, each variable is handled as a real number directly indicating a size of a figure. That is, respective elements xi (i=1, 2, . . . , 10) in the variable vector X are expressed using real numbers, and they correspond to pi (i=1, 2, . . . , 10) in FIG. 16.

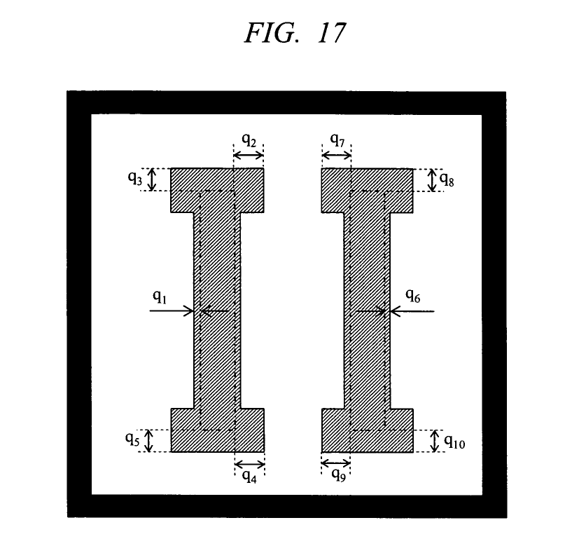

At this time, it is possible to adopt a difference from a design target as a chromosome expression without adopting a size itself. In the case shown in FIG. 17, for example, a shaded region is a mask pattern to which the OPC is applied, and an upper horizontal bar and a lower horizontal bar of an I-shaped figure are added in horizontally-symmetrical and vertically-symmetrical manners to a design target shown by a one-dotted chain line. Further, since thickness of a vertical bar can be changed in a horizontally-symmetrical manner, a mask pattern can be uniquely determined by designating respective sizes qi (i=1, 2, . . . , 10). That is, by regarding the variable vector X=(q1, q2, . . . , q10) as a chromosome, an optimal mask pattern can be obtained according to a genetic algorithm.

In the second embodiment, since the mask pattern where N_{cell} pieces of the same type of cells are arranged is handled, the length of the chromosome becomes N_{cell} times, and X=(X¹, X², . . . , X^{Ncell})=(x¹₁, . . . , x¹₁₀, . . . , x^{Ncell}₁, . . . , x^{Ncell}₂) is obtained. Here, X^{j} represents a variable vector constituted of 10 elements for indicating a figure shape included in the j-th cell, and x^{j}ᵢ represents i-th element of a variable vector corresponding to the j-th cell.

Alternatively, instead of representing respective elements xᵢ in the variable vector X using real values, respective elements xi of the variable vector X may be represented as n-adic numbers by determining an upper limit value, a lower limit value, and the number of quantizing steps.

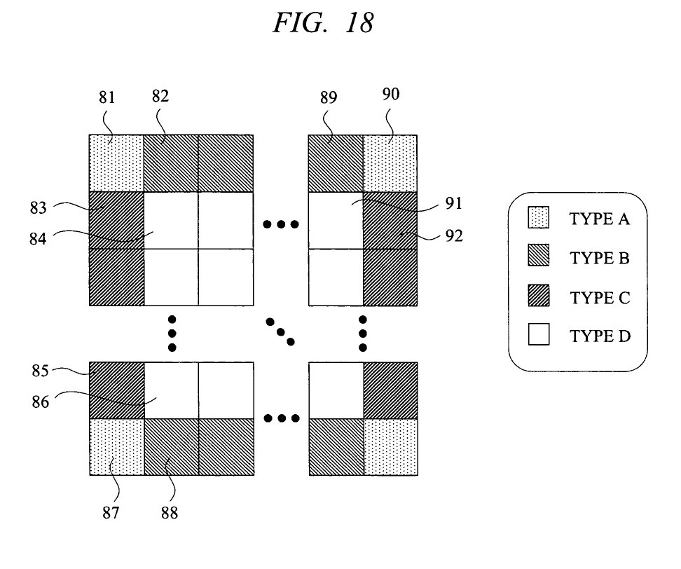

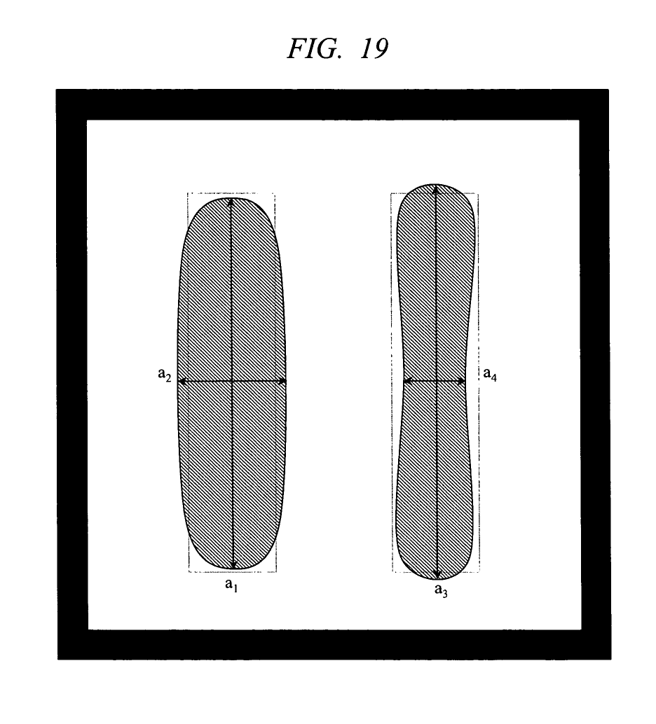

In the case of a memory where the same cells are arranged repeatedly and regularly, optimization can be facilitated by grouping all variable vectors of all cells to reduce the length of a chromosome instead of performing optimal value search to all the variable vectors of all the cells. In FIG. 18, for example, when it is assumed that all cells are each constituted of the same kind of figure pattern and the figure is vertically symmetrical and horizontally symmetrical, instead of adopting the variable vectors of all the cells as objects to be optimized, variable vectors of all cells are grouped to four types A to D, and only variable vectors (X¹ X². . . X⁴) defining the figures of four cells are optimized to apply the result to all the cells for each type. By this means, an effect similar to that obtained by adjusting the whole mask can be obtained. For example, in FIG. 18, regarding a cell 81, five upper and left side cells of eight surrounding cells are not present and three cells 82, 83, and 84 positioned on right and lower sides of the cell 81 are present. Also, a cell 90 is horizontally symmetrical and a cell 87 is vertically symmetrical to the cell 81 in relationship between themselves and surrounding cells (89, 92, and 91, and 88, 85, and 86). Accordingly, the result of optimization of the cell 81 can be used for the cell 90 and the cell 87. Thus, adjustment process for optimization can be omitted.

[Initialization: Determination of Evaluation Function]

As a method for obtaining fitness of a chromosome, a procedure similar to that in the first embodiment is adopted here. However, measurement of the size in step (3) is performed at four portions shown in FIG. 19. In an ordinary semiconductor chip manufacture, regarding required dimensional accuracy, portions where even a small error cannot be allowed and portions where high accuracy is not required are mixedly present. Therefore, the optimization which reflects the intention of a mask designer can be performed easily by selectively measuring the size of portions where high accuracy is required and performing fitness calculation thereto. Similarly, when it is possible to designate a portion where optical proximity can be often emerged in a stage of mask design, it is possible to preferentially perform the optimization from a portion where the adjustment is difficult by assigning large weight vale to the portion at a time of calculating the fitness.

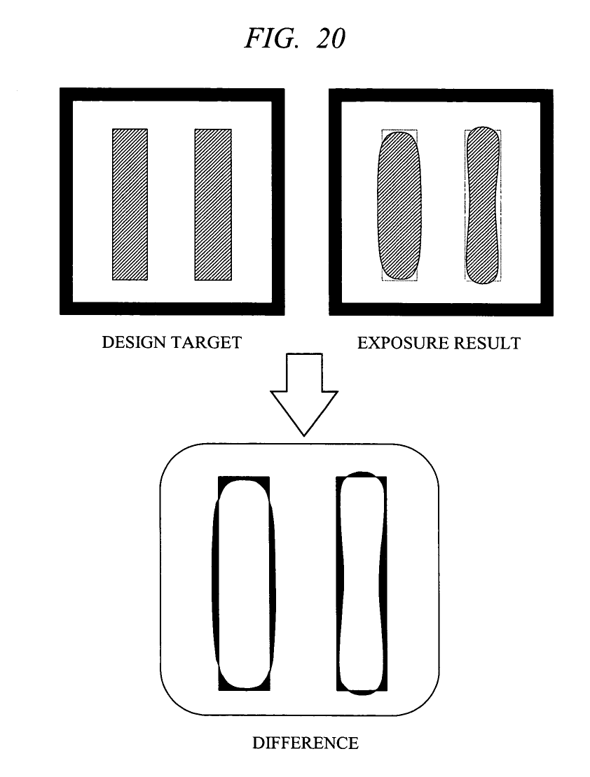

In the second embodiment, in order to compare a resist pattern predicted from simulation and a design value, sizes of several portions are measured in the step (3) of fitness calculation, and it becomes possible to completely detect unexpected errors at a portion whose size is not measured by using an area of a difference figure between the resist pattern and the design pattern as shown in FIG. 20. In this case, parameter optimization according to the genetic algorithm is performed utilizing reciprocal of the area of the difference figure or the like as the evaluation value.

Also, in the step (4) of fitness calculation, the reciprocal of the sum of errors is adopted as the fitness, but a subtraction value from a predetermined constant value can be adopted as the fitness.

Further, in the step (2) of fitness calculation, since a resist pattern can be predicted more accurately by additionally performing the simulation of acid diffusion, accuracy of the optimization can be improved.

[Initialization: Generation of Initial Chromosome Population]

Initial chromosome populations are generated at random similar to the first embodiment. In order to improve a search speed, the generation can be started from an initial population obtained by applying slight variation to a result corrected by model base OPC.

[Evaluation of Chromosome]

Similar to the first embodiment, all chromosomes are evaluated according to the evaluation procedure of chromosomes determined in the above “Initialization: Determination of Evaluation Function” and the fitness is calculated.

[Generation of Next-Generation population: Selection]

Similar to the first embodiment, the roulette selecting process is used. Alternatively, a selection method such as a tournament selection method or rank selection method or a generation alternation model such as an MGG (minimal generation gap) method can be used (Reference: “A New Generation Alternation Model of Genetic Algorithm and Its Assessment” by Sato et al., Journal of Japanese Society for Artificial Intelligence, Vol. 12, No. 5, 1997)

[Generation of Next-Generation Population: Crossover]

A uniform crossover is used similar to the first embodiment. Alternatively, a value obtained by weight-averaging may be used instead of exchange of gene locus selected at random.

In order to improve a search speed or accuracy, an UNDX (unimodal normal distribution crossover), a simplex crossover, or an EDX (extrapolation-directed crossover) which is the crossover procedure developed for a chromosome expressed with real number values, or the like can be used (Reference: “Optimization of non-linear function using real-coded GA: Problem and its Solution in Higher Dimension in Search Space” by Sakuma et al., 15^{th} National Convention of Japanese Society for Artificial Intelligence, 2nd Meeting for Youth MYCOM 2001, 2001).

When a chromosome is expressed using a binary vector, a multi-point crossover may be used besides the uniform crossover.

[Generation of Next-Generation Population: Mutation]

Mutation using random numbers generated according to a normal distribution is used similar to the first embodiment. In order to improve a search speed or accuracy, it is possible to use an adaptive mutation method, in which an improvement speed of fitness of a whole population is monitored and a mutation rate is temporarily increased when fitness is not improved for a certain time period or more.

[Termination Criterion of Search]

When the error from the design value becomes 0 or a fixed value or less or when the number of evaluation times for chromosome reaches a fixed value or more, search is terminated similar to the first embodiment.

The genetic algorithm used in the second embodiment has been described above. Moreover, the search speed and the accuracy can be improved by using other search methods such as a hill-climbing search, a simplex method, a steepest descent method, a simulated annealing, and a dynamic programming method in addition. A further search speed improvement and accuracy improvement can be realized by selectively using other blind search technique and a probabilistic search technique such as an evolution strategy (ES) and a genetic programming (GP).

As described above, since a semiconductor chip is produced using a cell library on which OPC process has been performed in advance and the influence of surrounding cell libraries is optimized utilizing the genetic algorithm which can perform the high speed process, a processing time can be reduced by one-tenth or less as compared with the conventional method that performs OPC process on all the patterns.

(Third Embodiment)

A system LSI having an SRAM portion and a logic circuit portion is manufactured using the mask pattern designing method described in the first embodiment. The minimum gate width of the system LSI is 40 nm, and the minimum pitch is 160 nm. The logic circuit portion allows arbitrary pitch wiring and does not require any arrangement restriction except for the minimum interval between cells. Therefore, the conventional IP can be inherited, high expansion property can be obtained as a platform, and a layout rule applicable to various kinds is provided.

When a correction pattern for the size is produced by a rule base OPC under the loose layout rule described above, variation occurs in a part of a gate pattern size in an active region. For example, necking or thickening occurs at a root portion near a pad, which deteriorates the device properties. There is such a problem that an exposure margin to exposure amount fluctuation or focus fluctuation is small and a yield as a semiconductor device is low. Also, it takes such a long time period as 7 days when a mask producing pattern is produced using a commercially available model base OPC.

Since the system LSI is directed to a specific user and a product cycle thereof is short, it must be manufactured for a short time period. The time period is the lifeline and it influences not only a value of the system LSI as a device but also marketability of a product incorporating the system LSI. When preferentially performed utilizing single-wafer process, a wafer process term requires at least two weeks, which is considered as quick mask supply. In order to achieve the producing period of a mask producing pattern as short as practical one day, a rule base must be partially applied in the conventional method, which causes such a problem as yield degradation as described above. When the mask pattern producing method described in the first embodiment is applied, a time required for mask pattern production is only one day, and device properties and yield equivalent to those in full application of the model base can be obtained. By applying the single-wafer process to the wafer process, a wafer process waiting time can be reduced and proper balance with a mask supplying rate can be achieved. As a result, shipping timing of the system LSI is accelerated.

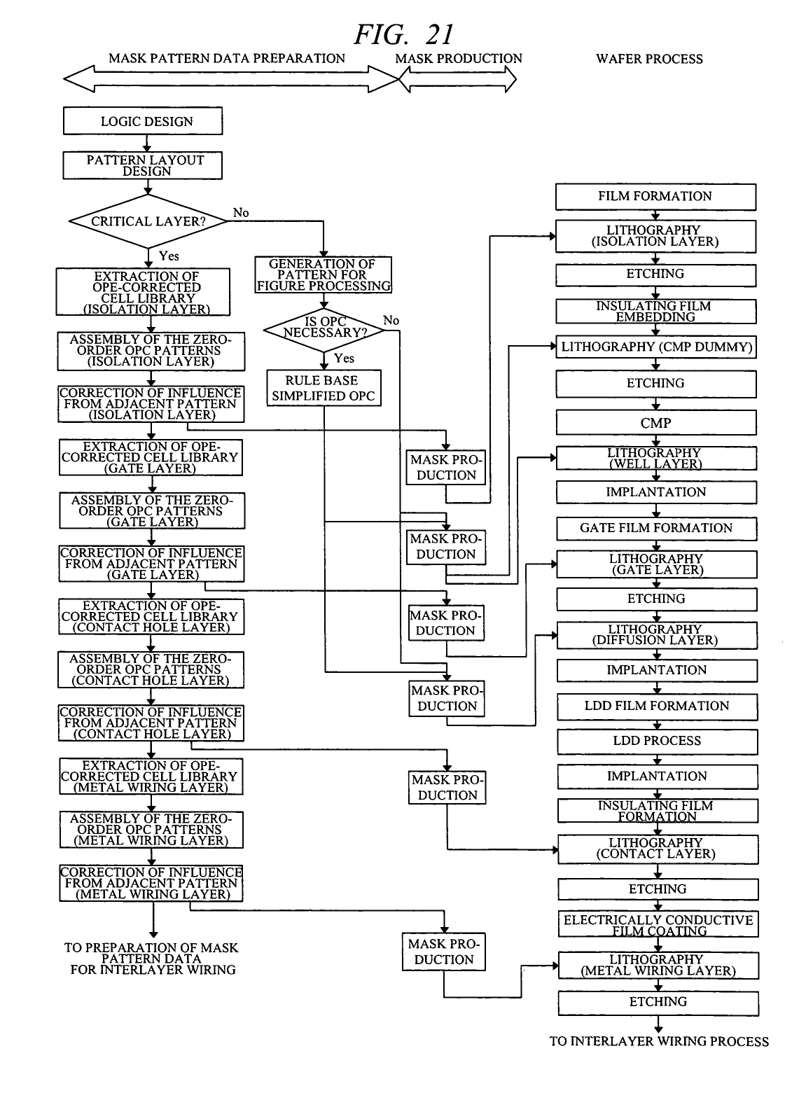

The above-described aspect will be described with reference to FIG. 21. FIG. 21 is a flowchart showing a mask pattern data preparation step, a mask producing step, and a wafer processing step for a system LSI. In FIG. 21, the mask pattern data preparation step is shown on the left side, the mask producing step is shown on the central side, and the wafer processing step and timings are shown on the right side.

When a pattern layout design based on a logic design is terminated, manufacture of an LSI is started. A wafer process flow includes a film formation for producing isolation (isolation between active regions), lithography, etching, insulating film embedding, lithography for CMP dummy pattern production for performing further planarization, etching, and CMP, and thus, the isolation is formed. Thereafter, lithography for selective implantation, formation of a well layer through implantation, film formation for a gate, lithography, etching, lithography for selective implantation, implantation, film formation for LDD, LDD processing, and implantation are performed to form a gate. Then, after an insulating film is formed, via holes are formed by performing lithography for contact hole and etching, and subsequently, a wiring layer is formed by performing lithography and etching after formation of an electrically conductive film. Then, though not illustrated, after an interlayer insulating film and openings are formed, an electrically conductive film is coated thereon, and interlayer wires are formed through CMP.

Masks have to be prepared so as to correspond to the wafer process flow. The masks are roughly classified into a mask for a critical layer which requires high dimensional accuracy and a mask for a non-critical layer. The former mask requires OPC with a enormous amount of data but the latter mask only requires simplified OPC, a simple figure calculation, or data itself. Typical critical layer includes isolation, a gate, a contact, and first and second wires.

After determination whether mask pattern OPC data corresponds to the critical layer, a manufacturing procedure is started. First, initially required isolation is prepared. Matching patterns are extracted from a cell library for OPE (Optical Proximity Effect) correction prepared in advance and the zero-order OPE-processed pattern is assembled by combining the matching patterns. Then, correction taking into account the influence from an adjacent pattern is performed based upon the genetic algorithm technique in the first embodiment to produce a final OPC pattern, and a mask is produced based upon the data thereof. Next, pattern data and masks for a gate layer, a contact layer, and a wiring layer are prepared in the same manner. A procedure for preparing respective layers in series has been shown here, but these layers may be prepared in parallel. However, when the layers are prepared in parallel, a plurality of data generation systems are required, which results in requirement for a large equipment. When the layers can be processed in series and the processing rate thereof matches with the wafer processing timely, such a merit can be obtained that a system can be reduced in size. Mask pattern data for the non-critical layer is prepared using another path as described above.

Since the isolation layer which is the critical layer is a layer formed initially, the delay of a mask preparation thereof directly leads to the delay of wafer delivery. Therefore, a mask pattern data completion period for the isolation layer is very important. In the third embodiment, the mask pattern data and the mask production can be attained in one day. That is, the preparation time can be reduced to half of the time required in the conventional preparation, namely, two days.

The process to the next lithography for a gate layer includes 9 steps in the rough classification, and it includes about 50 steps (not shown) if sub-steps such as a cleaning step are included. However, the process can be completed in two days by utilizing the single-wafer process. If a mask for a gate layer is not prepared during this period, loss due to waiting occurs. Since the gate requires very high dimensional accuracy, a time period of about one day is required for mask writing and its inspection. In this embodiment, the mask pattern data can be prepared in only one day though the preparation requires 7 days in the conventional method. If it requires 7 days for the preparation of the mask pattern data, it is impossible to catch up with a speed of the wafer processing even when pattern data preparation equipment is enlarged to start the data preparation in parallel with the isolation pattern production. In the method of the present invention, high-speed process matching with a speed of the single-wafer process can be performed utilizing relatively small-sized pattern data preparation equipment, and the system LSIs can be manufactured early.

Since the gate pattern requires a high dimensional accuracy, it is difficult to sufficiently acquire device properties by the rule base. However, since a complicated process is required in the mode base, a problem that a large amount of time is required for the pattern production appears more strongly than that in other layers. Accordingly, the present method is effective particularly for the gate pattern preparation.

(Fourth Embodiment)

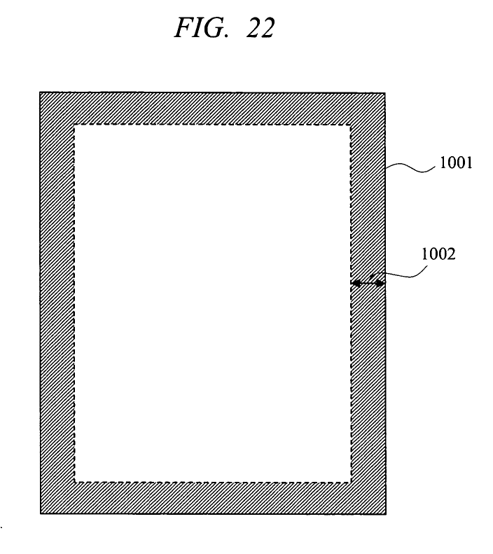

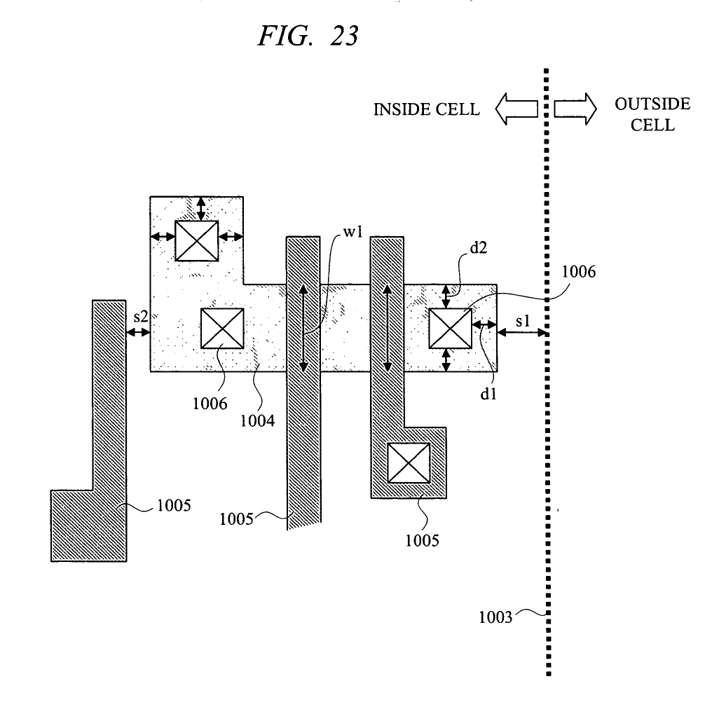

Another embodiment of a variable to be adjusted of the present invention will be described. In FIG. 22, reference numeral 1001 denotes a cell in a target cell library, and a pattern formed therein is obtained by performing OPC to a single cell. A region in this cell where a pattern to be corrected by OPC due to influence of surroundings is included is a hatched peripheral region, and a width 1002 of the region is about 2λ/NA though it depends on an exposure wavelength λ of an exposing apparatus, the numerical aperture NA of a lens used, an acid diffusion constant of resist used, standard size accuracy, and others.

A pattern layout example present in the peripheral region is shown in FIG. 23. In FIG. 23, reference numeral 1003 denotes a cell portion boundary region, 1004 denotes an active region (diffusion layer region), 1005 denotes a gate and a gate wire, and 1006 denotes a via hole (generally, called “contact”). An insulating region from the semiconductor substrate called “field” is positioned outside the active region 1004, and it is a region called “isolation”. A portion which requires the re-correction by OPC due to arrangement relationship between cells will be described for each of the active layer (isolation layer), the gate layer, and the contact layer.

[Isolation Layer]

A gate width w1, alignment margins between a contact and a diffusion layer d1 and d2, an avoidance margin of resolution failure (pattern connection failure) between adjacent cells s1, and an avoidance margin of riding failure of a gate wire over a diffusion layer s2 shown in FIG. 23 are portions to be re-adjusted by OPC. When the gate width w1 does not fall within a regulation accuracy, deterioration of transistor characteristics due to a narrow channel effect occurs, and when alignment margins between a contact and a diffusion layer d1 and 2 can not be secured, conduction failure due to increase in contact resistance occurs.

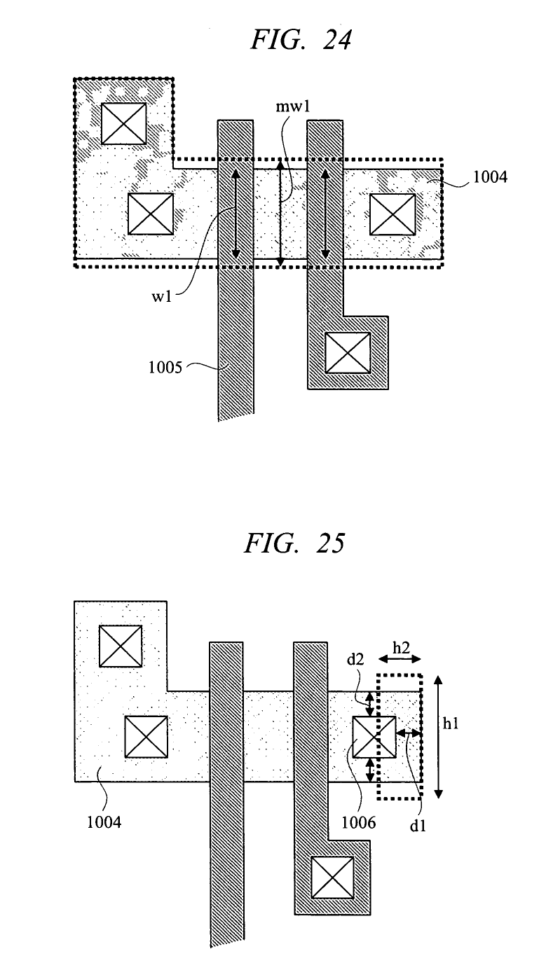

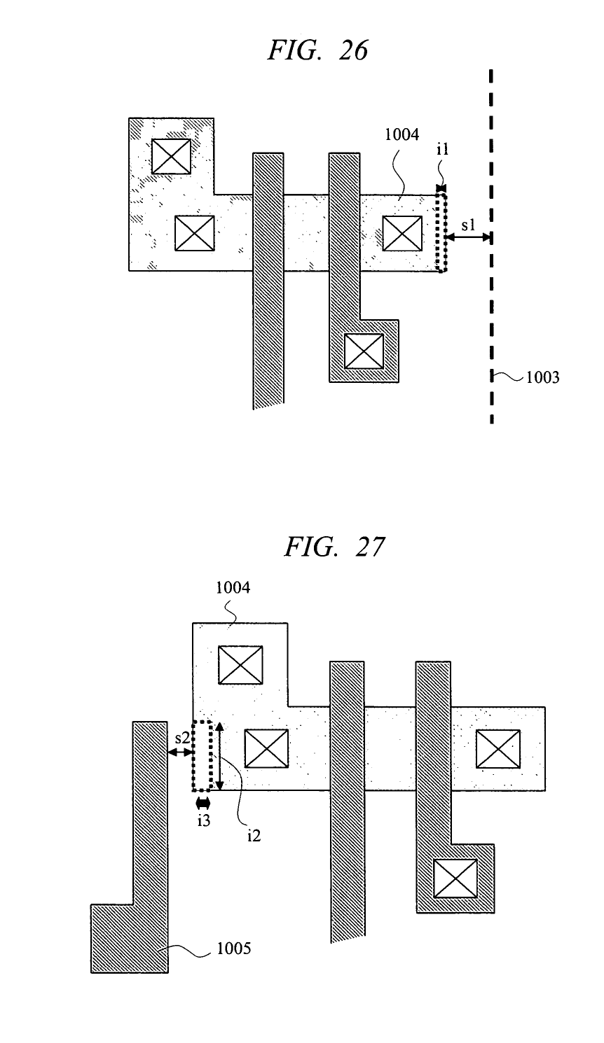

An example of a variable to be adjusted in an active region will be described with reference to FIG. 24 to FIG. 27. FIG. 24 shows a practical example of an adjustment variable for the gate width w1, where a width mw1 is adjusted using the above-described genetic algorithm technique. FIG. 25 shows practical examples of adjustment variables for the alignment margins between a contact and a diffusion layer d1 and d2, where an end portion of a diffusion layer is formed into a hammer head shape with a width h1 and a length h2 and adjustment is performed using the above-described genetic algorithm technique. FIG. 26 shows an actual example of avoidance of a resolution failure (pattern connection failure) between adjacent cells, where a retraction amount at a distal end of the active region 1004 is defined as a variable i1. FIG. 27 shows an example of avoidance of riding failure of a gate wire over a diffusion layer, where a length i3 and a width i2 of a retraction region at a portion facing the gate wire 1005 are the variables. These variables are adjusted using the above-described genetic algorithm technique.

[Gate Layer]

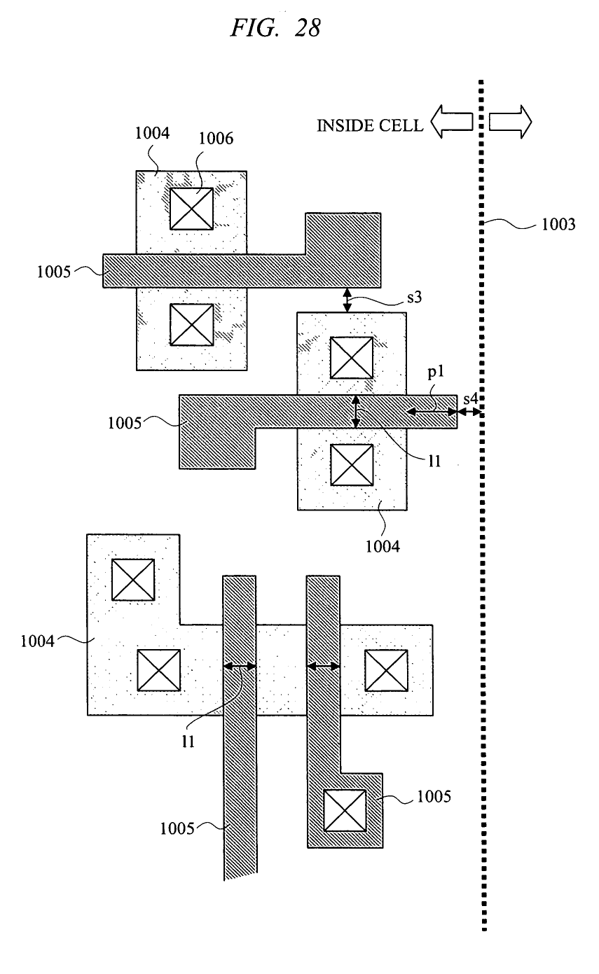

A gate length 11, an avoidance margin of resolution failure (pattern connection failure) between adjacent cells s4, an avoidance margin of riding failure of a gate wire over a diffusion layer s3, and a projecting amount from an active region p1 shown in FIG. 28 are portions to be re-adjusted by OPC. When a gate length 11 does not fall within a regulation accuracy, a threshold voltage of a transistor becomes uncontrollable and transistor characteristics significantly fluctuate, and a circuit operation becomes unstable.

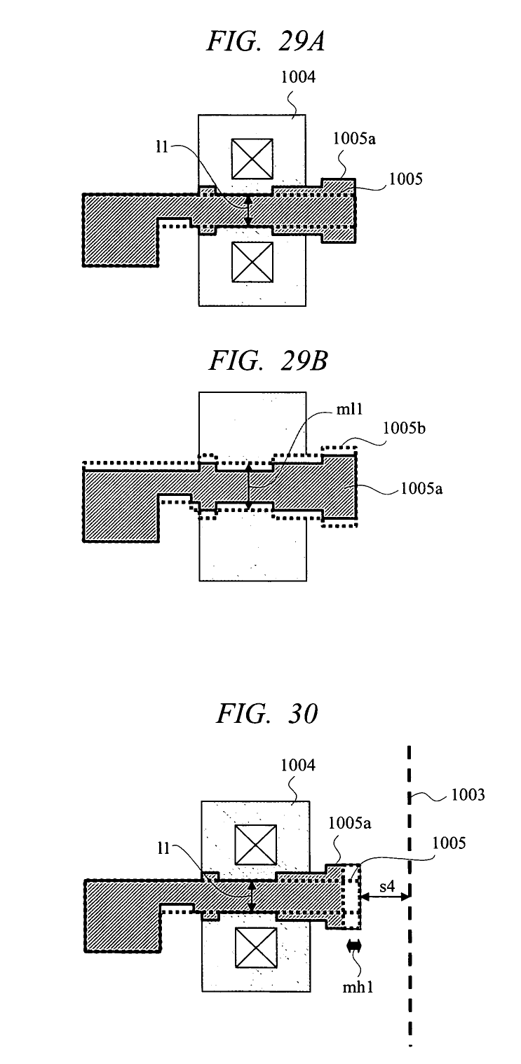

An example of variables to be adjusted of a gate and a gate wire pattern will be described with reference to FIG. 29 to FIG. 32.

FIG. 29A and FIG. 29B show a practical example of an adjustment variable of the gate length l1. Since the accuracy of gate length influences the transistor characteristics most sensitively, a particularly high dimensional accuracy is required. Since a pad is generally formed on a portion of a gate wire in order to take electrical connection to a wiring layer, a transfer pattern is deformed due to influence of diffracted light from the portion. In order to prevent the deformation at least on the active region, complicated OPC such as shown by the reference numeral 1005a in FIG. 29A is performed. In this case, OPC is performed so that desired dimensional accuracy can be first obtained in a single cell. Thereafter, adjustment is performed with reference to another cell pattern arranged in the periphery utilizing the above-described genetic algorithm technique with using the line width ml1 as a variable, while maintaining an outer shape of the OPC, as shown in FIG. 29B.

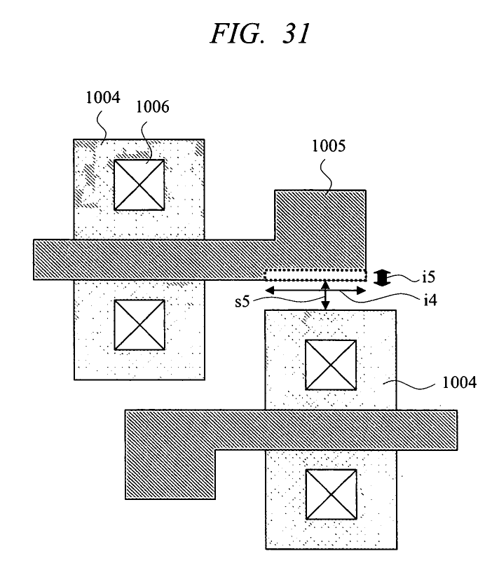

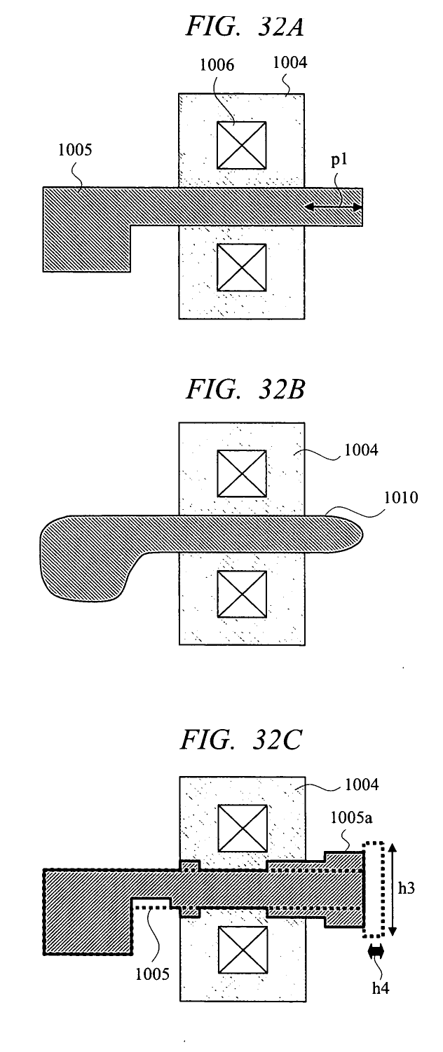

FIG. 30 shows an example of avoidance of resolution failure (pattern connection failure) between adjacent cells. A retraction amount mh1 at a distal end of a gate wiring pattern 1005a to which the OPC in the case of a single cell is performed is the variable. FIG. 31 shows an example of avoidance of riding failure of a gate wire over a diffusion layer, where the variables are a width i4 and a depth i5 of a retracted portion of a gate wire facing a diffusion layer (active layer) 1004. FIG. 32A to FIG. 32C show examples of the correction of projection from an active region. A design layout is a rectangular layout as shown in FIG. 32A, but a pattern end is formed in such a rounded shape as shown in FIG. 32B due to diffraction of the exposure light and acid diffusion of resist when pattern transfer is actually performed. When the rounded portion overlaps with the active region, transistor characteristics deteriorate due to such a phenomenon as punch-through. Therefore, a projection amount equal to a fixed amount or more must be secured. As shown in FIG. 32C, variables in this case are a width h3 and a length h4 of a hammer head at the gate end. These variables are adjusted using the above-described genetic algorithm technique.

[Contact Layer]

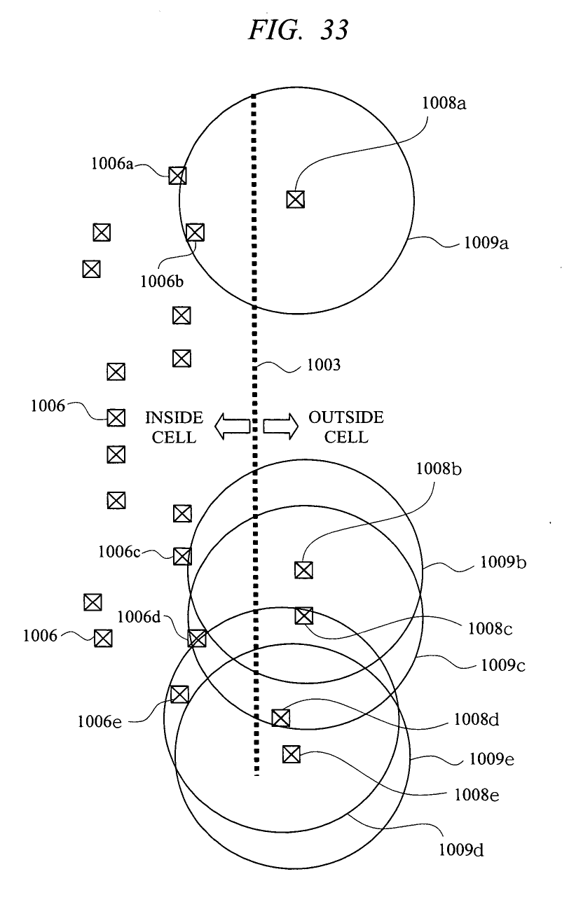

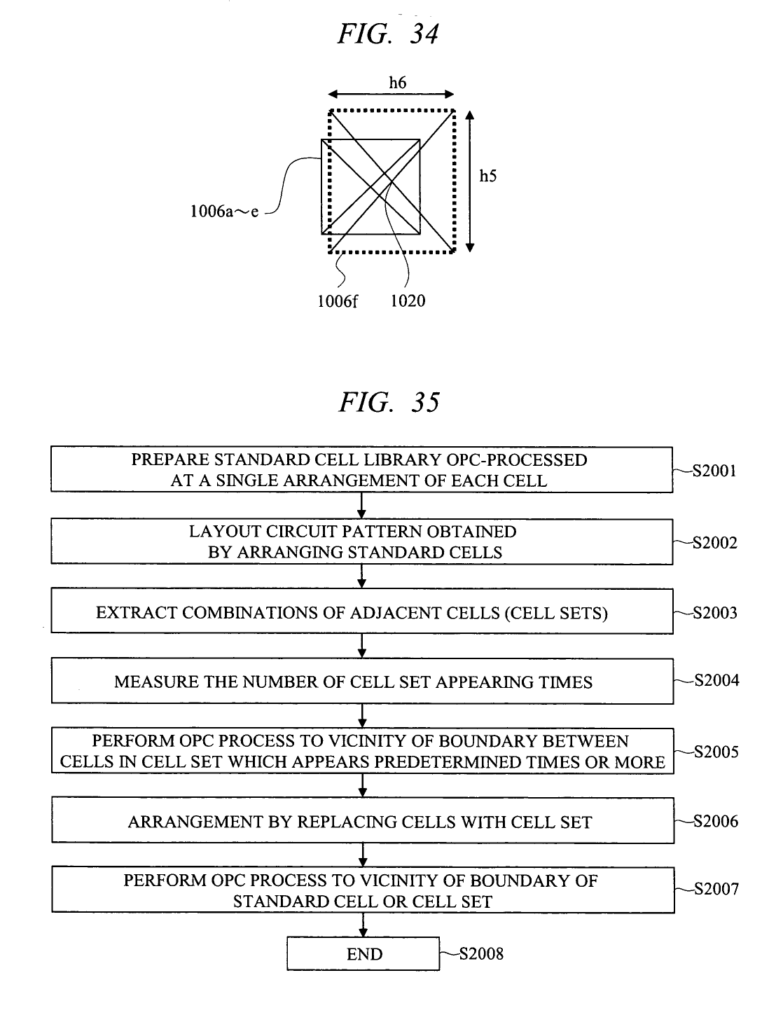

FIG. 33 shows an example of a layout of a contact layer. Patterns which are re-corrected by the OPC due to influence from external cells are patterns laid in interactive regions 1009a to 1009e from patterns 1008a to 1008e of external cells, which are denoted by reference numerals 1006a to 1006e in FIG. 33. A radius of the interactive regions is about 2λ/NA though it depends on an acid diffusion constant of a resist, a standard dimensional accuracy, and others. As shown in FIG. 34, variables of a pattern 1006f to which the OPC is performed again are a height h5 and a width h6, and positional deviation correction is performed with using a center position 1020 of the pattern 1006f as a variable. These variables are adjusted using the above-described genetic algorithm technique.

(Fifth Embodiment)

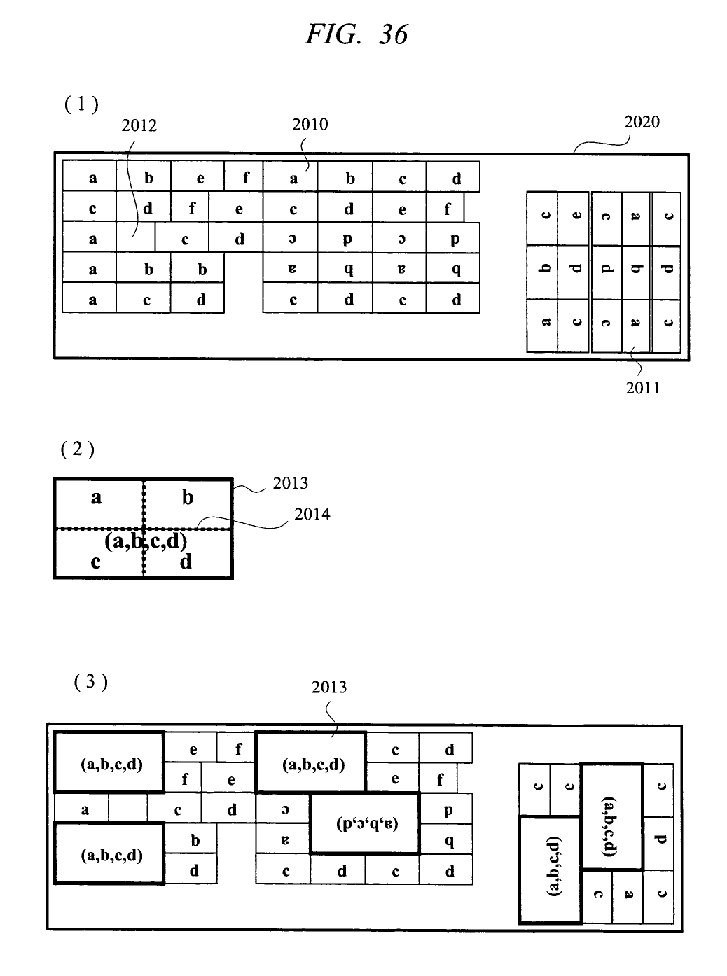

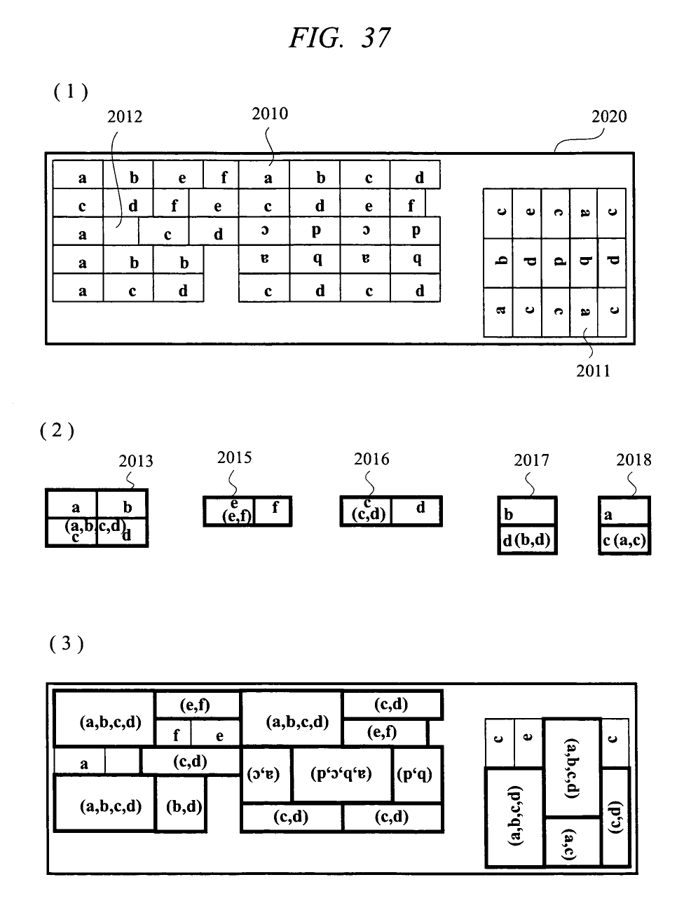

In a fifth embodiment, a group of cells surrounded by cells with the same variation is regarded as one block constituting a cell set so as to further improve the OPC processing efficiency, and a procedure thereof will be described with reference to FIG. 35.

(1) First, a group of cells subjected to the OPC process at the time when each cell is arranged as a single cell is prepared as a standard cell library (step S2001).

(2) Next, standard cells are utilized to form a layout of a circuit pattern where a plurality of the standard cells are arranged (step S2002).

(3) Next, combinations of adjacent cells are extracted in a hierarchy level from which a cell arrangement can be understood (step S2003). The combinations of cells are called “cell set”. At this time, the cell sets in which the cells have the same proximity distance and the same portion relationship are defined as the same cell sets.

(4) Next, the number of appearance times of the same cell set, namely, how many times the same cell set is used in a circuit layout, is examined (step S2004).

(5) Next, when a cell set is used predetermined times or more, re-adjustment by OPC is performed to the vicinity of a boundary portion between cells used in the cell set, and then, the cell set is registered in the library (step S2005).

(6) Next, as shown in FIG. 36A to FIG. 36C and FIG. 37A to FIG. 37C, cells are replaced with a registered cell set (step S2006). That is, cells 2010 arranged on a chip 2020 are replaced with a block of cells (cell set) 2013 including the same sells. In this case, a cell boundary portion 2014 in the cell set 2013 is subjected to re-correction by OPC in advance. Since a length of a cell is different for each cell, a space 2012 may be formed in a cell arrangement. Also, the cells may be rotated 90° or 180° as shown in the cells 2010 and 2011.

(7) Re-adjustment process by OPC to the vicinity of the standard cell and the cell set boundary portion is performed for a circuit pattern where a standard cell, a cell set, and other patterns are arranged (step S2007).

The object of the present invention is achieved in the above manner. Note that FIG. 36A to FIG. 36C show the case where an appearance level of a cell set is high and only one cell set is replaced, and FIG. 37A to FIG. 37C show the case where the appearance level is reduced. The cell set may be constituted of four cells or two cells. A side to be a cell boundary is important.

Further, by using the genetic algorithm process for the above-described OPC correction, the time for the re-correction by OPC can be reduced.

Since the conventional OPC process is performed to all figures on a mask defining a circuit pattern of a semiconductor chip, it has such a drawback that a processing time becomes enormous due to increase of the number of figures according to miniaturization. According to the first to fifth embodiments described above, however, OPC process is performed to each of the cells and the processed cells are stored, all figures of a mask are constituted of the combinations of the stored cells, and the OPC adjustment process between cells is performed to all the figures of the mask. In this manner, the processing time can be significantly reduced.

The reason why the processing time can be reduced is as follows. That is, since the OPC process for each cell is stored as a library in advance and the library is used between products in common, an OPC processing time for each of products is substantially occupied by the OPC process between cells, and the number of combinations (the number of parameters) is significantly reduced as compared with the case where the OPC process is performed to all figures of a mask. As a result, a converging time to the optimization is remarkably reduced.

In the fifth embodiment, a cell group where arrangements of surrounding cells including a target cell are the same is extracted, and the cell group is registered as a cell set. Then, the same cell set is produced by copying without re-calculating the OPC of a cell boundary portion therein. More specifically, a pattern group with the same arrangement is produced by copying. Since the same arrangement is searched in units of cell, a process for searching the patterns with the same arrangement is facilitated, which contributes to the reduction in processing time. By producing pattern groups with the same arrangement by copying, the number of steps can be significantly reduced and a processing time can be also shortened largely. Therefore, an OPC system can be made compact and the cost can be also reduced.

Therefore, since the same arrangement is searched in units of cell, a process for searching patterns with the same arrangement is facilitated, which contributes to the reduction in processing time.

By using the mask pattern designing method and the designed device using the optical proximity correction of the photolithography according to the present invention, such a significant advantage can be obtained that a mask pattern design for a large scale integrated circuit in a manufacturing method of a semiconductor device is increased in speed and facilitated, and therefore, a mask pattern can be produced at high speed and at a low cost.

Accordingly, since a mask pattern can be produced at a high speed and at a low cost, a large scale integrated circuit can be manufactured efficiently, and occurrence of such a failure as disconnection in a manufactured large scale integrated circuit can be reduced. Therefore, reliability is improved and yield thereof is also improved.

Further, since the design time of a mask pattern in the present invention is reduced by about one digit as compared with the conventional design time, such an advantage can be obtained that cost reduction of custom IC using a large number of mask patterns can be achieved and industrial applicability thereof can be expanded. For example, development of system LSI for digital home information appliances obtained through the high-mix low-volume production can be achieved at low cost.

In the foregoing, the invention made by the inventors of the present invention has been concretely described based on the embodiments. However, it is needless to say that the present invention is not limited to the foregoing embodiments and various modifications and alterations can be made within the scope of the present invention.

The present invention can be utilized in the field of manufacturing a semiconductor device, electronic appliances, and the like.

1. A mask pattern designing method according to claim 3, comprising:
(a) a step of performing, to cells, a process of first optical proximity correction for correcting a shape change occurring when exposing a mask pattern to form a pattern and registering a cell group of the cells in a cell library;
(b) a step of arranging a plurality of cells using said cell library to design a mask pattern;
(c) a step of extracting cell groups with the same cell arrangement;
(d) a step of performing second optical proximity correction in which a correction amount in the first optical proximity correction performed to said cell in said cell library is changed with taking into account influence of a cell pattern arranged around the cell; and
(e) a step of copying a result of the second optical proximity correction in said step (c) to said extracted cell groups with the same cell arrangement.

2. A mask pattern designing method according to claim 3, comprising:
(b1) a step of arranging a plurality of cells to design a mask pattern by using a cell library in which a cell group to which a process of first optical proximity correction for correcting a shape change occurring when exposing a mask pattern to form a pattern has been performed has been registered;
(c) a step of extracting cell groups with the same cell arrangement;
(d) a step of performing second optical proximity correction in which a correction amount in the first optical proximity correction performed to said cell in said cell library is changed with taking into account influence of a cell pattern arranged around the cell; and
(e) a step of copying a result of the second optical proximity correction in said step (c) to said extracted cell groups with the same cell arrangement.

3. A mask pattern designing method comprising:
(c1) a step of extracting cell groups with the same cell arrangement for a mask pattern where a plurality of cells have been arranged by using a cell library in which a cell group to which a process of first optical proximity correction for correcting a shape change occurring when exposing a mask pattern to form a pattern has been performed has been registered;
(d) a step of performing second optical proximity correction in which a correction amount in the first optical proximity correction performed to said cell in said cell library is changed with taking into account influence of a cell pattern arranged around the cell; and
(e) a step of copying a result of the second optical proximity correction in said step (c) to said extracted cell groups with the same cell arrangement.

4. The mask pattern designing method according to claim 1,
wherein a genetic algorithm is used for said second optical proximity correction.

5. The mask pattern designing method according to claim 2,
wherein a genetic algorithm is used for said second optical proximity correction.

6. The mask pattern designing method according to claim 3,
wherein a genetic algorithm is used for said second optical proximity correction.

7. The mask pattern designing method according to claim 1,
wherein the same arrangement is extracted in units of side and the result of said second optical proximity correction is copied.

8. The mask pattern designing method according to claim 2,
wherein the same arrangement is extracted in units of side and the result of said second optical proximity correction is copied.

9. The mask pattern designing method according to claim 3,
wherein the same arrangement is extracted in units of side and the result of said second optical proximity correction is copied.

10. A mask pattern designing method according to claim 12, comprising:
(f) a step of performing first optical proximity correction performed as a result of pattern transfer formation at the time when a cell has been singularly arranged and registering a cell group of the cells in a cell library;
(g) a step of arranging a plurality of cells using said cell library;
(h) a step of extracting combinations of adjacent cells from a pattern where said plurality of cells are arranged;
(i) a step of extracting a combination which appears predetermined times or more from the combinations as a cell set;
(j) a step of performing second optical proximity correction for correcting pattern deformation occurring from mutual interference due to proximity between cells near a boundary of the cells constituting said cell set; and
(k) a step of performing third optical proximity correction for correcting pattern deformation occurring from mutual interference between patterns due to proximate arrangement of a plurality of cells or said cell sets.

11. A mask pattern designing method according to claim 12, comprising:
(g1) a step of arranging a plurality of cells by using a cell library where a cell group to which first optical proximity correction is performed as a result of pattern transfer formation at the time when a cell has been singularly arranged has been registered;
(h) a step of extracting combinations of adjacent cells from a pattern where said plurality of cells are arranged;
(i) a step of extracting a combination, which appears predetermined times or more from said combinations, as a cell set;
(j) a step of performing second optical proximity correction for correcting pattern deformation occurring from mutual interference due to proximity between cells near a boundary of the cells constituting said cell set; and
(k) a step of performing third optical proximity correction for correcting pattern deformation occurring from mutual interference between patterns due to proximate arrangement of a plurality of cells or said cell sets.

12. A mask pattern designing method comprising:
(h1) a step of extracting combinations of adjacent cells from a pattern where a plurality of cells are arranged, by using a cell library where a cell group to which first optical proximity correction is performed as a result of pattern transfer formation at the time when a cell has been singularly arranged has been registered;
(i) a step of extracting a combination, which appears predetermined times or more from said combinations, as a cell set;
(j) a step of performing second optical proximity correction for correcting pattern deformation occurring from mutual interference due to proximity between cells near a boundary of the cells constituting said cell set; and
(k) a step of performing third optical proximity correction for correcting pattern deformation occurring from mutual interference between patterns due to proximate arrangement of a plurality of cells or said cell sets.

13. A method for manufacturing a semiconductor device using a mask produced through the process according to claim 15, comprising:
(a) a step of performing, to cells, a process of first optical proximity correction for correcting a shape change occurring when exposing a mask pattern to form a pattern and registering a cell group of the cells in a cell library;
(b) a step of arranging a plurality of cells using said cell library to design a mask pattern;
(c) a step of extracting cell groups with the same cell arrangement;
(d) a step of performing second optical proximity correction in which a correction amount in the first optical proximity correction performed to said cell in said cell library is changed with taking into account influence of a cell pattern arranged around the cell; and
(e) a step of copying a result of the second optical proximity correction in said step (c) to said extracted cell groups with the same cell arrangement.

14. A method for manufacturing a semiconductor device using a mask produced through the process according to claim 15, comprising:
(b1) a step of arranging a plurality of cells to design a mask pattern by using a cell library in which a cell group to which a process of first optical proximity correction for correcting a shape change occurring when exposing a mask pattern to form a pattern has been performed has been registered;
(c) a step of extracting cell groups with the same cell arrangement;
(d) a step of performing second optical proximity correction in which a correction amount in the first optical proximity correction performed to said cell in said cell library is changed with taking into account influence of a cell pattern arranged around the cell; and
(e) a step of copying a result of the second optical proximity correction in said step (c) to said extracted cell groups with the same cell arrangement.

15. A method for manufacturing a semiconductor device using a mask produced through the process comprising:
(c1) a step of extracting cell groups with the same cell arrangement for a mask pattern where a plurality of cells have been arranged by using a cell library in which a cell group to which a process of first optical proximity correction for correcting a shape change occurring when exposing a mask pattern to form a pattern has been performed has been registered;
(d) a step of performing second optical proximity correction in which a correction amount in the first optical proximity correction performed to said cell in said cell library is changed with taking into account influence of a cell pattern arranged around the cell; and
(e) a step of copying a result of the second optical proximity correction in said step (c) to said extracted cell groups with the same cell arrangement.

16. A method for manufacturing a semiconductor device using a mask produced through the process according to claim 18, comprising:
(f) a step of performing first optical proximity correction performed as a result of pattern transfer formation at the time when a cell has been singularly arranged and registering a cell group of the cells in a cell library;
(g) a step of arranging a plurality of cells using said cell library;
(h) a step of extracting combinations of adjacent cells from a pattern where said plurality of cells are arranged;
(i) a step of extracting a combination which appears predetermined times or more from the combinations as a cell set;
(j) a step of performing second optical proximity correction for correcting pattern deformation occurring from mutual interference due to proximity between cells near a boundary of the cells constituting said cell set; and
(k) a step of performing third optical proximity correction for correcting pattern deformation occurring from mutual interference between patterns due to proximate arrangement of a plurality of cells or said cell sets.

17. A method for manufacturing a semiconductor device using a mask produced through the process according to claim 18, comprising:
(g1) a step of arranging a plurality of cells by using a cell library where a cell group to which first optical proximity correction is performed as a result of pattern transfer formation at the time when a cell has been singularly arranged has been registered;
(h) a step of extracting combinations of adjacent cells from a pattern where said plurality of cells are arranged;
(i) a step of extracting a combination, which appears predetermined times or more from said combinations, as a cell set;
(j) a step of performing second optical proximity correction for correcting pattern deformation occurring from mutual interference due to proximity between cells near a boundary of the cells constituting said cell set; and
(k) a step of performing third optical proximity correction for correcting pattern deformation occurring from mutual interference between patterns due to proximate arrangement of a plurality of cells or said cell sets.

18. A method for manufacturing a semiconductor device using a mask produced through the process comprising:
(h1) a step of extracting combinations of adjacent cells from a pattern where a plurality of cells are arranged, by using a cell library where a cell group to which first optical proximity correction is performed as a result of pattern transfer formation at the time when a cell has been singularly arranged has been registered;
(i) a step of extracting a combination, which appears predetermined times or more from said combinations, as a cell set;
(j) a step of performing second optical proximity correction for correcting pattern deformation occurring from mutual interference due to proximity between cells near a boundary of the cells constituting said cell set; and
(k) a step of performing third optical proximity correction for correcting pattern deformation occurring from mutual interference between patterns due to proximate arrangement of a plurality of cells or said cell sets.
